(19) United States
(12) Patent Application Publication
(10) Pub. No.: US 2010/0279076 A1
(43) Pub. Date: Nov. 4, 2010

(54) Manufacturing Method of Round Surface Panel and Manufacturing Apparatus of Round Surface Panel, Round Panel Lining, and Construction Method of Round Panel

(76) Inventor: Seung Han KIM, Seoul (KR)

Correspondence Address: PARK LAW FIRM, 3255 WILSHIRE BLVD, SUITE 1110, LOS ANGELES, CA, 90010, US

(21) Appl. No.: 12/529,055

(22) PCT Filed: Feb. 27, 2008
(86) PCT No.: PCT/KR2008/001151

§ 371 Date: Jan. 14, 2010

(30) Foreign Application Priority Data
Feb. 28, 2007 (KR) 10-2007-0020059
Feb. 28, 2007 (KR) 10-2007-0020061
Feb. 28, 2007 (KR) 10-2007-0020064

(51) Int. Cl. B32B 3/00; B29C 47/00; B23P 11/00

(52) U.S. Cl. 428/174; 425/103; 264/145; 29/525.11; 29/428

(57) ABSTRACT

The present invention relates to a curved panel (3200) which is used to construct a tunnel in addition to an arch shaped underground or aboveground structure. The curved panel (3200) has a curved shape corresponding to the arch shape of the tunnel or the structure, thus increasing supporting force, thereby ensuring the structural stability, reducing the construction time, and enhancing the constructability and economic efficiency thereof. Furthermore, the present invention provides a method of manufacturing the curved panel (3200), an apparatus for manufacturing the curved panel (3200), a curved panel lining, and a curved panel construction method.

### TECHNICAL FIELD

The present invention relates, in general, to curved panels and, more particularly, to a curved panel which is used to construct a tunnel in addition to an underground or aboveground arch structure, the curved panel having a curved shape corresponding to the arch shape of the tunnel or the structure, thus increasing supporting force, thereby ensuring the structural stability, reducing the construction time, and enhancing the constructability and economic efficiency.

### BACKGROUND ART

Generally, in Korea, because of geographical features, when constructing expressways, national roads, railways or urban roads which pass through mountain districts, the construction of tunnels is indispensable.

Most of the tunnels are formed through mountainous areas or deep underground. Such tunnels are typically supported by stable base rocks, but the tunnels may be supported even by unstable base rocks using locking bolts, shotcrete or steel ribs or through other support construction methods. As such, the stability of the tunnels can be ensured merely using primary tunnel supports.

However, to date, to ensure long-term stability and cope with unexpected loads, and for convenience in repair and maintenance and to function as a finish, lining has been implemented only using concrete or reinforced concrete after the primary tunnel supports are installed.

In most cases, lining is constructed for a finish. Because the lining is constructed after blasting excavation has been performed, there is the possibility of a crack in the lining attributable to various causes, such as imbalance of a cross-section, heat of hydration, early removal of a mold, etc.

Due to such causes, the lining for finishing may rather make passersby uneasy and deteriorate the appearance of the tunnel. Furthermore, in the case of concrete lining, because concrete has a strength lower than metal and has a relatively large weight to a volume, the cross-section of a lining member is increased. Therefore, the size of the excavation area for the tunnel is increased, so that there is a disadvantage in that the construction costs are increased.

In addition, an expensive steel mold is required to cast concrete. Due to the curing of concrete, movement and installation of the mold, and assembly of reinforcing bars, it takes about half of the construction time of the tunnel to construct the lining. Thus, the construction time of the tunnel is increased, so that the timetable for completion of construction of the tunnel is not met. As well, an indirect cost of the tunnel construction relative to total construction cost is increased.

Recently, in an effort to overcome these problems, a precast lining construction method has been introduced. However, because the weight of members relative to strength is too large, relatively expensive large equipment is required. Furthermore, there are disadvantages in that it is difficult to install devices for holding the rear surfaces of lining members, and thus a relatively large space behind the rear surfaces of the lining members is required.

Moreover, although a shear key is provided between adjacent precast panels, the panels must be installed using locking bolts or anchors rather than being independently installed. Even if the panels are independently installed, because the members are too large, the constructability is reduced, and the cross-sectional area of excavation for the tunnel is increased.

Meanwhile, in addition to the precast lining construction method, other methods, in which panels are used in the tunnel in place of the use of the mold, panels are fastened using locking bolts, and panels are inserted between H-beams that are used as supports, have been attempted. However, there are problems in that the constructability and economic efficiency are reduced.

### DISCLOSURE OF INVENTION

### Technical Problem

Accordingly, the present invention has been made keeping in mind the above problems occurring in the prior art, and an object of the present invention is to provide a method of manufacturing a curved panel which is used to construct a tunnel in addition to constructing an underground or aboveground arch structure, the curved panel having a curved shape corresponding to the arch shape of the tunnel or the structure, thus increasing supporting force, thereby ensuring the structural stability, reducing the construction time, and enhancing the constructability and economic efficiency, and an apparatus for manufacturing the curved panel, a curved panel lining and a curved panel construction method.

### Technical Solution

In order to accomplish the above object, the present invention provides a method of manufacturing a curved panel, an apparatus for manufacturing the curved panel, a curved panel lining and a curved panel construction method.

In the method of manufacturing a curved panel, the curved panel is manufactured by bending a fiber reinforcing member, in which fiber is embedded in resin, to form a curved surface in a longitudinal direction thereof. The method includes: primarily shaping the fiber reinforcing member into a planar shape; primarily hardening the primarily shaped fiber reinforcing member; secondarily shaping the primarily hardened fiber reinforcing member such that the primarily hardened fiber reinforcing member is bent into a curved shape; secondarily hardening the secondarily shaped fiber reinforcing member by passing the secondarily shaped fiber reinforcing member through a heating room; and continuously drawing the secondarily hardened fiber reinforcing member and cutting the fiber reinforcing member.

Alternatively, the method may include primarily shaping the fiber reinforcing member such that the fiber reinforcing member is bent into a curved shape; secondarily shaping the primarily shaped fiber reinforcing member such that the primarily shaped fiber reinforcing member is bent into a curved shape; hardening the secondarily shaped fiber reinforcing member by passing the secondarily shaped fiber reinforcing member through a heating room; and continuously-drawing the secondarily hardened fiber reinforcing member and cutting the fiber reinforcing member.

As a further alternative, the method may include: exposing the fiber reinforcing member to a heating device and primarily shaping the fiber reinforcing member such that the fiber reinforcing member is bent into a curved shape; bending the primarily shaped fiber reinforcing member into a curved shape and hardening the fiber reinforcing member; and drawing the hardened fiber reinforcing member into a curved shape using a drawing roller and cutting the fiber reinforcing member.

Thus, the curved surface of the fiber reinforcing member is formed in a direction in which the fiber reinforcing member is drawn.

Here, in the fiber reinforcing member, the fiber may be embedded in the resin before the fiber is formed. The fiber may be embedded in the resin after the fiber is formed. After the fiber is formed, the formed fiber may be inserted in a mold, and a predetermined amount of resin may be injected into the mold using a pump, thus embedding the fiber in the resin.

The fiber reinforcing member may be continuously drawn by a drawing unit. The drawing unit may include a holder to hold the fiber reinforcing member, and guide walls, each of which has a bent shape, the guide walls guiding the holder which guides the fiber reinforcing member in the longitudinal direction.

The holder may include a holder body to surround the fiber reinforcing member, a hydraulic jack to fasten the fiber reinforcing member to the holder body, and rollers provided on respective opposite ends of the holder body, wherein the rollers are moved along guide slots, which are formed in the respective guide wall, thus drawing the fiber reinforcing member along the guide walls.

The fiber reinforcing member may be continuously drawn by a drawing unit, which comprises an endless track device. The endless track device may include a pair of gears which rotate using power supplied from an external power source, and an endless track belt having a contact surface of a predetermined width, the endless track belt being wrapped at opposite positions around the gears, so that the endless track belt is moved by the rotation of the gears in an endless track traveling manner, wherein the endless track belt travels along a curved line, and the endless track device comprises a pair of endless track devices, which are respectively disposed above and below the fiber reinforcing member to compress the fiber reinforcing member upwards and downwards and move the fiber reinforcing member.

The fiber reinforcing member may be continuously drawn by a drawing unit, which comprises a roller device. The roller device may include one or more rollers to apply force to the fiber reinforcing member upwards or downwards, wherein, while the fiber reinforcing member is drawn, the curved shape of the fiber reinforcing member is maintained by differences in size and rotating force between the rollers.

Meanwhile, at least one core may be provided in the fiber reinforcing member. The core may be shaped into a curved shape.

The core may be shaped before the fiber is formed, so that, when the fiber is formed, the core is supplied to the fiber, and the fiber and the core are placed in the mold and a predetermined amount of resin is injected into the mold to embed the fiber and core in the resin, thus forming the fiber reinforcing member, the fiber reinforcing member being shaped by a curved surface forming mold.

The curved surface forming mold may move in a direction, in which the fiber reinforcing member is moved, and shape the fiber reinforcing member in a stationary state of the fiber reinforcing member.

Furthermore, a composite structure may be formed on each of opposite ends of the fiber reinforcing member by a post-process device, wherein the post-process device comprises an end forming mold coupled to each of the opposite ends of the fiber reinforcing member to form the composite structure, and upper and lower molds are provided on the upper and lower surfaces of the fiber reinforcing member to apply pressure and heat thereto, each of the upper and lower molds having a predetermined curvature.

The fiber reinforcing member may be provided with a reinforcing sheet for thermal/fire resistance, surface treatment, or reinforcement.

Meanwhile, the apparatus for manufacturing a curved panel includes: a fiber supply unit to supply a fiber, a resin supply unit to supply resin to the fiber to form a fiber reinforcing member; a forming unit to shape the fiber reinforcing member; a drawing unit to continuously draw the shaped fiber reinforcing member; and a cutting unit to cut the drawn fiber reinforcing member. The fiber reinforcing member is bent such that the fiber reinforcing member has a curved surface in a longitudinal direction thereof.

For this, the forming unit may include a first forming part to primarily shape the fiber reinforcing member into a planar shape, a first hardening part to primarily harden the primarily shaped fiber reinforcing member, a second forming part to secondarily shape the primarily hardened fiber reinforcing member by bending the primarily hardened fiber reinforcing member into a curved shape, and a second hardening part to secondarily harden the secondarily shaped fiber reinforcing member. Alternatively, the forming unit may include a first forming part to primarily shape the fiber reinforcing member into a curved shape, a second forming part to secondarily shape the primarily-formed fiber reinforcing member into a curved shape, and a second hardening part to heat and harden the secondarily shaped fiber reinforcing member. As a further alternative, the forming unit may include a first forming part to primarily shape the fiber reinforcing member into a curved shape, and a second forming part to secondarily shape the primarily formed fiber reinforcing member into a curved shape and harden the fiber reinforcing member. Thus, a curved surface is formed in the panel in a direction, in which the panel is drawn.

The drawing unit may include a holder to hold the fiber reinforcing member, and guide walls, each of which has a bent shape, the guide walls guiding the holder which guides the fiber reinforcing member in the longitudinal direction.

The holder may include a holder body to surround the fiber reinforcing member, a hydraulic jack to fasten the fiber reinforcing member to the holder body, and rollers provided on respective opposite ends of the holder body, wherein the rollers are moved along guide slots, which are formed in the respective guide wall, thus drawing the fiber reinforcing member along the guide walls.

The drawing unit may comprise an endless track device. The endless track device may include a pair of gears to rotate using power supplied from an external power source, and an endless track belt having a contact surface of a predetermined width, the endless track belt being wrapped at opposite positions thereof around the gears, so that the endless track belt is moved by the rotation of the gears in an endless track traveling manner, wherein the endless track belt travels along a curved line, and the endless track device comprises a pair of endless track devices, which are respectively disposed above and below the fiber reinforcing member to compress the fiber reinforcing member upwards and downwards and move the fiber reinforcing member.

The drawing unit may comprise a roller device. The roller device may include one or more rollers to apply force to the fiber reinforcing member upwards or downwards, wherein, while the fiber reinforcing member is being drawn, the curved shape of the fiber reinforcing member is maintained by differences in size and rotating force between the rollers.

The apparatus for manufacturing the curved panel may further include a post-process device, comprising an end forming mold coupled to each of opposite ends of the fiber reinforcing member to form a composite structure, and upper and lower molds provided on the upper and lower surfaces of the fiber reinforcing member to apply pressure thereto, each of the upper and lower molds having a predetermined curvature.

In addition, the apparatus for manufacturing the curved panel may further include an angle adjustment unit to adjust a height of the forming unit, such that the direction in which the fiber reinforcing member is discharged from the forming unit, is adjusted, wherein heights of the guide walls are adjustable along guide wall supports, so that the guide walls are controlled depending on a curved shape of the fiber reinforcing member.

Meanwhile, the curved panel lining include: a plurality of composite lining members, each of which has a predetermined width and has a predetermined curvature with respect to a longitudinal direction thereof; and connection means for connecting the adjacent lining members to each other.

Thus, the lining is disposed in an arch shape in an arch direction of the arch structure, thus ensuring a structural stability, and reducing construction time.

Each of the composite lining members comprises an upper curved plate having a predetermined curvature in a longitudinal direction thereof, a lower curved plate corresponding to the upper curved plate, and a connection curved member interposed between the upper curved plate and the lower curved plate, the connection curved member has one or more kinds of cross-sectional shape and cross-sectional area determined depending on a shape of a mold used to manufacture the connection curved member.

The connection curved member has a polygonal cross-section or a circular cross-section in the longitudinal direction, in which the connection curved member is curved.

Furthermore, a plurality of adhesion protrusions may be provided on an outer surface of the lining member.

The connection means may include a coupling member interposed between the adjacent lining members, the coupling member covering outer surfaces of facing ends of the adjacent lining members, and a bolt unit for bolting the coupling member to the lining members.

The connection means may include a coupling member interposed between the adjacent lining members, the coupling member covering outer surfaces of the facing ends of the adjacent lining members, and an adhesive means applied between the coupling member and the lining members.

Here, uneven surfaces to be locked to each other may be formed in contact surfaces between the coupling member and the lining members.

The connection means may include a pair of coupling members interposed between the lining member, the coupling members being coupled to respective facing ends of the adjacent lining members. The coupling members may have respective coupling protrusions, so that the coupling members are coupled to each other by connection between the coupling protrusions.

The connection means may include a pair of coupling members interposed between the lining member, the coupling members being coupled to respective facing ends of the adjacent lining members. The coupling members may be coupled to each other using a coupling insertion locked to both the coupling members.

Alternatively, the connection means may include coupling parts formed in respective facing ends of the adjacent lining members, and a connection member interposed between the lining members, the connection member being coupled at opposite ends thereof to the respective coupling parts. Each of the coupling parts may be a depression formed in the corresponding end of each of the lining members. The connection member may include a protrusion body inserted at opposite ends thereof into the respective depressions, and a center body provided in a central portion of the protrusion body, the center body being disposed between the lining members such that the center body is brought into close contact with the lining members.

Here, the depression may have a round inner surface, and the protrusion body may have a round outer surface such that the protrusion body comes into close contact with the depression.

Furthermore, upper and lower surfaces of the coupling member may protrude outwards from the outer surfaces of the lining members. The upper and lower surface of the coupling member may be rounded.

The connection means may comprise a connector having a predetermined length. The connector may be interposed between the adjacent lining members and coupled to facing ends of the adjacent lining members. The connector may have upper and lower surfaces of different lengths.

The connector may have a first space, into which insert material is inserted, and a second space connected to the first space, the second space being filled with reinforcing material, so that the length of the connector is changed by insertion of the insert material in a state wherein the reinforcing material is charged into the second space.

In addition, a reinforcing panel may be attached to outer surfaces of the lining members.

As well, concrete may be applied to outer surfaces of the lining members.

Meanwhile, the curved panel construction method for constructing a lining, which is manufactured using panels and constructed in an arch structure, includes: preparing a plurality of composite curved panels, each of which has a predetermined width and has a predetermined curvature with respect to a longitudinal direction thereof, the composite curved panels having one or more kinds of cross-sectional shapes and cross-sectional areas; boring the arch structure or leveling a ground; and installing the prepared curved panels in the arch structure in an arch direction of the arch structure to form a curved shape, thus reducing a construction time, and increasing a supporting force. The installation of the curved panels comprises installing precast panel supports in the arch structure, and supporting the curved panel on the installed precast panel supports, wherein, while the arch structure is bored, the curved panels are consecutively installed, and, thereafter, the precast panel supports, on which the curved panels are supported, are covered with finishing material in one operation.

Here, a height adjustment device may be provided on the precast panel supports, so that heights of the curved panels are adjusted using the height adjustment device.

Alternatively, the curved panel construction method for constructing a lining, which is manufactured using panels and constructed in an arch structure, may include: preparing a plurality of composite curved panels, each of which has a predetermined width and has a predetermined curvature with respect to a longitudinal direction thereof, the composite curved panels having one or more kinds of cross-sectional shapes and cross-sectional areas; boring the arch structure or leveling a ground; and installing the prepared curved panels in the arch structure in an arch direction of the arch structure to form a curved shape, thus reducing a construction time, and increasing a supporting force. In the installation of the curved panels, after the arch structure is bored to a predetermined distance, concrete structures for supporting the curved panels are installed, and the curved panels are installed in one operation such that the curved panels are supported by the concrete structures.

Here, guides may be provided on upper ends of the concrete structures, and lower ends of the curved panels may be inserted into the corresponding guides, so that the curved panels are installed in the arch structure by pushing the curved panels from one end of the arch structure into the arch structure under guidance of the guides.

Furthermore, a filler may be charged between the curved panels and an inner surface of the arch structure.

In addition, an injection hole may be formed in the curved panel, so that the filler is injected through the injection hole. The injection hole may be a threaded hole, through which the filler passes, and a stop bolt may be inserted into the threaded hole to openably close the threaded hole.

As well, a gap may be defined between the curved panels and an inner surface of the arch structure.

Each of the curved panels may be fastened to a base rock, in which the arch structure is placed, using a locking bolt. The locking bolt may be brought into close contact with the curved panel. The locking bolt may be spaced apart from the curved panel by a predetermined distance. Furthermore, a cap nut may be provided on a rear surface of the curved panel so that an end of the locking bolt is fitted into the cap nut.

Moreover, after the arch structure is bored, a first lining may be formed by arranging linear panels, each of which has a round cross-section and has a predetermined length, around an inner surface of the arch structure, and a second lining may be formed by covering the first lining with the curved panels.

Here, the first lining may be formed by supplying to and installing the linear panels in the arch structure after the linear panels are assembled with each other, the second lining may be formed by supplying to and installing the curved panels in the arch structure after the curved panels are assembled with each other, or by directly installing the curved panels at installation positions in the arch structure, the arch structure may be further bored and additional linear panels are supplied into and installed in the arch structure, and additional curved panels may be installed in the arch structure.

When a damaged portion occurs on portion of outer surfaces of the curved panels, an adhesive may be applied to the damaged portion, and a high-strength reinforcing fiber sheet may be attached to the portion to which the adhesive is applied.

When a damaged part occurs in one curved panel, the damaged part may be removed from the curved panel, a connection panel may be installed in a portion of the curved panel from which the damaged part has been removed, and a replacement panel may be connected to the curved panel through the connection panel.

### Advantageous Effects

In the present invention, a curved panel, which is used to construct a tunnel in addition to an underground or aboveground arch structure, has a curved shape corresponding to the arch shape of the tunnel or the structure, thus increasing supporting force, thereby ensuring the structural stability, reducing the construction time, and enhancing the constructability and economic efficiency.

Furthermore, the present invention facilitates connecting lining panels to each other in the lateral direction, that is, along the direction of the arch. As well, the connection between the lining panels in the longitudinal direction, that is, along the direction of the tunnel, to form a curved shape can be easily conducted and firmly maintained. Therefore, the structural stability is ensured, the construction time is reduced, the constructability and economic efficiency are increased.

In the present invention, a connector may be used to connect the facing ends of the adjacent lining members to each other. In this case, coupling members protrude from the connector, and coupling depressions are formed in the facing ends of the lining members, so that the coupling members are inserted into the respective coupling depressions. Thus, the lining members can be firmly coupled to each other.

In addition, when the lining members are connected to each other in the longitudinal direction, even if a gap between the lining members occurs, the gap can be easily eliminated. Furthermore, a width of the curved panel lining can be adjusted.

In an arch tunnel structure, in the case where curved panels are combined with linear panels for reinforcement of the arch tunnel, the supporting force can be markedly enhanced.

In the case where a base rock is stable, because the bored base rock has been stably maintained for a long period time in an unsupported state, it is unnecessary to conduct the lining construction as soon as the base rock is bored. Therefore, installation of the lining panels and back-filling thereof can be conducted at a position which is not affected by blasting. In the case where a base rock is unstable, because the bored base rock must be reinforced as soon as the base rock is bored, back-filling material is mixed with quick-setting agent such that it sets rapidly when the lining is constructed, thus preventing a reduction in strength of concrete attributable to blasting vibration.

Furthermore, the construction method using the curved panels of the present invention facilitates construction of a road tunnel, a railway tunnel, a waterway tunnel, a multi-stage tunnel, a tunnel formed using a shield TBM or an open TBM, a vertical tunnel, a tunnel having a ventilation duct, a rock prevention tunnel, an ecological tunnel, an underground roadway, a tunnel formed under an obstruction, a cut-and-cover tunnel and temporary structures for various purposes, and arch structures, such as gymnasiums.

### BRIEF DESCRIPTION OF THE DRAWINGS

FIGS. 1 through 3 are views showing an embodiment of an apparatus and a method of manufacturing a curved panel according to the present invention;

FIGS. 4 through 8 are views showing an embodiment of a drawing unit according to the present invention;

FIG. 9 is a view showing an embodiment of a forming unit according to the present invention;

FIG. 10 is a view illustrating embodiments of a forming mold according to the present invention;

FIG. 11 is a view showing the construction of a forming mold that can produce various sizes of products;

FIG. 12 is a view showing a fiber reinforcing member, which is manufactured using a core according to the present invention;

FIG. 13 is a view showing an apparatus and a method of manufacturing a curved panel using the core according to the present invention;

FIG. 14 is a view illustrating an embodiment of a curved surface forming mold according to the present invention;

FIG. 15 is a view illustrating another embodiment of a curved surface forming mold according to the present invention;

FIG. 16 is a view showing another method of manufacturing a curved panel according to the present invention;

FIG. 17 is a view showing an embodiment of post-processing according to the present invention;

FIG. 18 is a view showing a structure which can manufacture curved panels having various curvatures according to the present invention;

FIG. 19 is a view showing the construction state of curved panel linings according to the present invention;

FIG. 20 is a sectional view of a curved panel lining according to the present invention;

FIGS. 21 through 23 are views showing embodiments of structures of coupling the curved panel linings to each other with respect to a lateral direction according to the present invention;

FIGS. 24 through 38 are views showing embodiments of structures of coupling the curved panel linings to each other with respect to a longitudinal direction according to the present invention;

FIG. 39 is a view showing a reinforcing panel for reinforcing the curved panel lining according to the present invention;

FIG. 40 is a view showing the curved panel lining integrated with concrete for reinforcement thereof according to the present invention;

FIG. 41 is a sectional view showing a tunnel constructed by the curved panel construction method according to the present invention;

FIGS. 42 and 43 are views showing precast panel support according to an embodiment of the present invention;

FIG. 44 is a sectional view showing a tunnel constructed by a curved panel construction method according to another embodiment of the present invention;

FIG. 45 is a view showing a method of constructing a concrete structure according to another embodiment of the present invention;

FIG. 46 is a view showing other embodiments of the concrete structure of FIG. 45;

FIGS. 47 through 48 are views showing guides installed in the concrete structures according to the present invention;

FIG. 49 is a view showing another embodiment of a concrete structure according to the present invention;

FIG. 50 is a sectional view showing the operation of the concrete structure of FIG. 49;

FIG. 51 is a sectional view taken along the line A-A of FIG. 49;

FIG. 52 is a view showing a method of carrying curved panels into a tunnel after assembling the curved panels with each other outside the tunnel according to the present invention;

FIG. 53 is a view showing a method of carrying curved panels after assembling the curved panels with each other in the tunnel according to the present invention;

FIGS. 54 through 57 are views showing a method of directly assembling the curved panels with each other in a tunnel according to the present invention;

FIG. 58 is a sectional view showing an injection hole formed through a curved panel according to the present invention;

FIG. 59 is a sectional view showing another injection hole formed through a curved panel according to the present invention;

FIG. 60 is a sectional view showing a locking bolt, which is integrally coupled to the curved panel according to the present invention;

FIG. 61 is a sectional view showing a locking bolt, which is removably coupled to the curved panel according to the present invention;

FIG. 62 is a sectional view showing cap nuts provided on the rear surfaces of the curved panels according to the present invention;

FIG. 63 is a view showing the cap nuts shown in FIG. 62;

FIG. 64 is a view showing a curved panel construction method, according to another embodiment of the present invention;

FIG. 65 is a view showing a method of constructing curved panels and linear panels according to the construction method of FIG. 64;

FIG. 66 is a view showing the coupling of curved panels using connection members according to the present invention;

FIG. 67 is a sectional view showing curved panels applied to a multi-stage tunnel according to the present invention;

FIG. 68 is a sectional view showing curved panels applied to a tunnel, having a ventilation duct therein, according to the present invention;

FIG. 69 is a sectional view showing curved panels applied to a tunnel formed using a shield TBM according to the present invention;

FIG. 70 is a sectional view showing curved panels applied to another tunnel formed using a shield TBM according to the present invention;

FIG. 71 is a sectional view showing a method for constructing a cut-and-cover tunnel;

FIG. 72 is a view showing a method for constructing a vertical shaft;

FIG. 73 is a view showing the repair of a damaged portion in a curved panel according to the present invention;

FIG. 74 is a view showing a damage which has occurred in a curved panel according to the present invention; and

FIG. 75 is a view showing the repair of the damaged portion shown in FIG. 74.

### DESCRIPTION OF THE ELEMENTS IN THE DRAWINGS

1100: fiber supply unit 1200: resin supply unit

1300: forming part 1310: first forming part

1320: second forming part 1330: first hardening part

1340: second hardening part 1350: forming mold

1351: curved surface forming mold 1360: heating room

1370: fiber forming mold 1380: pump

1390: drive motor 1391: guide rail

1400: drawing unit 1410: guide wall

1420: support 1430: holder body

1500: endless track device 1550: roller device

1600: angle adjusting unit 1700: reinforcing sheet

1710: end forming mold 1720: upper mold

1730: lower mold

2100: lining member 2120: extension member

2150: connector 2190: uneven surface

2300: connection member 2200: connection means

2210: coupling member 2235: coupling insertion

2240: adhesion means 2250: reinforcing panel

2251: reinforcing protrusions and depressions

3100: tunnel 3200: curved panel

3200′: sleeve panel 3200″: replacement panel

3200″': connection panel 3300: concrete structure

3310: concrete body 3320: reinforcing bar

3330: anchor bolt 3340: base angle bar

3350: fastening angle bar 3342: first guide

3360: second guide 3370: third guide

3400: locking bolt 3410: coupling bolt

3420: cap nut 3500: precast panel support

3510: support body 3520: screw bolt

3530: planar plate 3540: inclined part

3550: support blade 3560: locking bolt

3600: linear panel

### BEST MODE FOR CARRYING OUT THE INVENTION

Hereinafter, an apparatus for manufacturing a curved panel according to the present invention will be described, and, thereafter, a method of manufacturing a curved panel using the apparatus will be described.

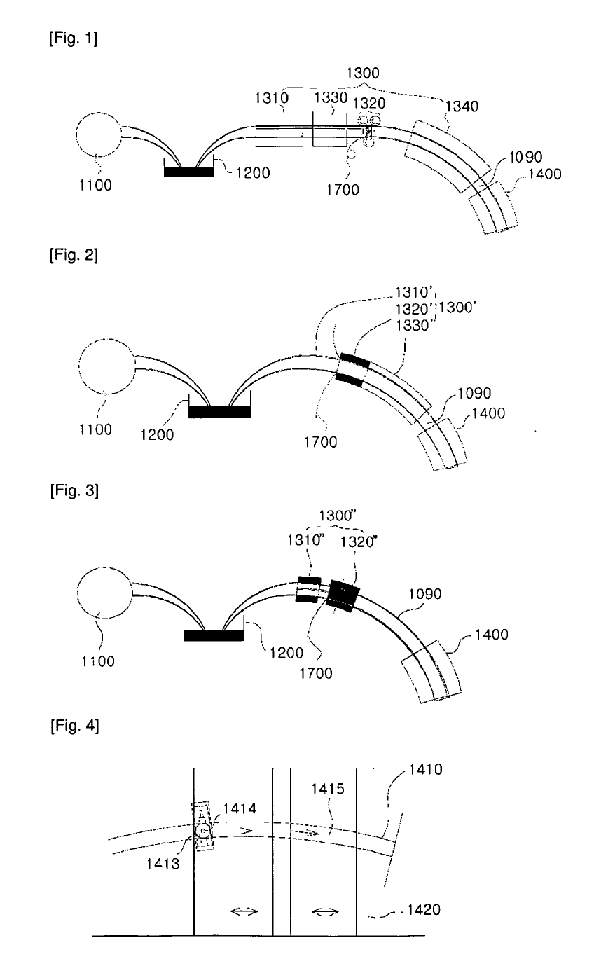

Referring to FIGS. 1 through 3, the curved panel manufacturing apparatus of the present invention includes a fiber supply unit 1100, which supplies fiber, and a resin supply unit 1200, which supplies resin to the fiber to form a fiber reinforcing member 1090. The curved panel manufacturing apparatus further includes a forming unit 1300, which shapes the fiber reinforcing member 1090, a drawing unit 1400, which continuously draws the shaped fiber reinforcing member 1090 at a predetermined curvature along a lateral direction (or a longitudinal direction) thereof, and a cutting unit (not shown), which cuts the fiber reinforcing member 1090 that is continuously produced.

As shown in FIG. 1, the forming unit 1300 includes a first forming part 1310, which primarily shapes the fiber reinforcing member 1090 into a planar shape, and a first hardening part 1330, which primarily hardens the primarily shaped fiber reinforcing member 1090. The forming unit 1300 further includes a second forming part 1320, which secondarily shapes the primarily hardened fiber reinforcing member 1090 through a method of bending it into a curved shape, and a second hardening part 1340, which secondarily hardens the secondarily shaped fiber resin forcing member 1090 to maintain the curved shape. Here, the fiber reinforcing member 1090 is drawn and guided by the drawing unit 1400 in the state in which it is hardened, and, thereafter, the fiber reinforcing member 1090 is discharged to the cutting part. Therefore, continuous production can be realized.

Alternatively, as shown in FIG. 2, a forming unit 1300′ may include a first forming part 1310′, which primarily shapes the fiber reinforcing member 1090 into a curved shape, a second forming part 1320′, which secondarily shapes the primarily shaped fiber reinforcing member 1090 into a curved shape, and a hardening part 1330′, which heats the secondarily shaped fiber reinforcing member 1090 at a predetermined temperature and thus hardens it.

As a further alternative, as shown in FIG. 3, a forming unit 1300″ may include a first forming part 1310″, which primarily shapes the fiber reinforcing member 1090 into a curved shape, and a second forming pan 1320″, which secondarily shapes the primarily shaped fiber reinforcing member 1090 into a curved shape and, simultaneously, heats and hardens it.

Meanwhile, referring to FIGS. 4 through 6, the drawing unit 1400 includes a holder, which holds the fiber reinforcing member 1090, and guide walls 1410, each of which has a bent shape, and which guide the holder. That is, the guide walls 1410 serve to guide the fiber reinforcing member 1090 in a longitudinal direction. The guide walls 1410 are supported by supports 1420, which are provided at several positions.

Here, the holder includes a holder body 1430, which surrounds the fiber reinforcing member 1090, hydraulic jacks 1431, which fasten the fiber reinforcing member 1090 to the holder body 1430, and rollers 1413, which are provided on the respective opposite ends of the holder body 1430. The rollers 1413 are movable along respective guide slots 1415, which are formed in the respective guide walls 1410. The fiber reinforcing member 1090 is drawn along the guide walls 1410.

As a method of applying actuating force to the holder, as shown in FIG. 6, the hydraulic jacks may be coupled to the holder body 1430 such that force can be applied in the longitudinal direction. Alternatively, a method, in which the holder is pushed or pulled using separate a wire, a gear or a chain, may be used.

As shown in FIG. 6, preferably, the rollers 1413 are rotatably coupled to respective roller shafts 1414 of the holder body 1430 and are constructed such that they can be varied in position relative to the supports 1420.

Therefore, various kinds of fiber reinforcing members 1090 having different curvature radii can be formed merely by replacing the forming unit 1300 with another. The various fiber reinforcing members 1090 can be drawn merely by replacing the guide walls 1410 with another one having the corresponding curvature radius.

Meanwhile, as shown in FIG. 7, the drawing unit 1400 may comprise an endless track device 1500.

The endless track device 1500 includes a pair of gears 1520, which rotate using power supplied from the outside, and an endless track belt 1510, which has a contact surface having a predetermined width and is wrapped at opposite ends thereof around the gears 1520, so that the endless track belt 1510 is moved by the rotation of the gears 1520 in an endless track traveling manner. In this case, the fiber reinforcing member 1090 is continuously moved and drawn by the rotation of the endless track belt 1510.

The endless track device 1500 may comprise a pair of endless track devices 1500, which are constructed such that they are disposed above and below the fiber reinforcing member 1090 and thus move the fiber reinforcing member 1090 under pressure.

The contact surface of the endless track belt 1510 which contacts the fiber reinforcing member 1090 is rounded to respond to various kinds of fiber reinforcing members 1090 having different curvature radii. To achieve this purpose, through holes 1511 are formed in the endless track belt 1510, and the belt passes over stationary shafts, which are arranged at a predetermined curvature radius, so that the endless track belt 1510 forcibly travels along a curved line having a corresponding curvature radius. Furthermore, depending on the size or thickness of the fiber reinforcing member 1090, the number of gears 1520 may be increased or reduced.

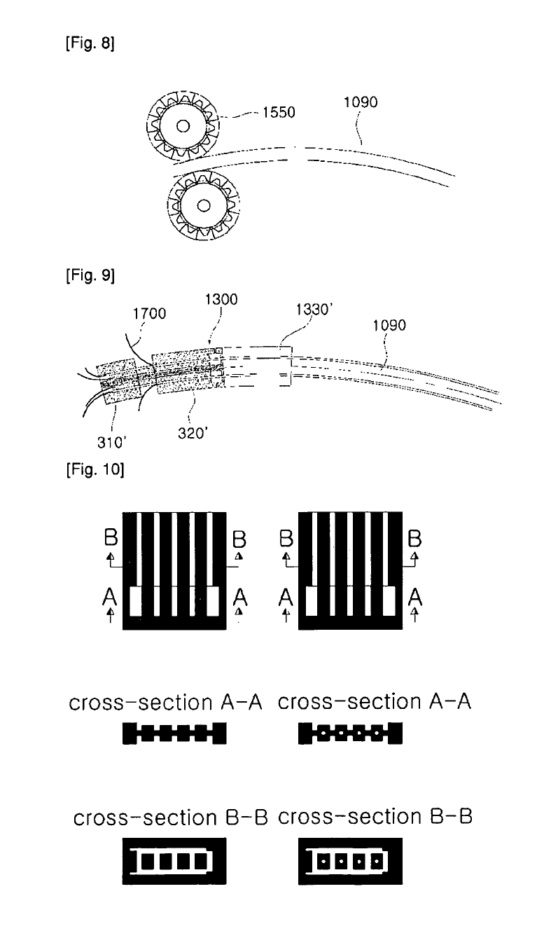

Alternatively, as shown in FIG. 8, the drawing unit 1400 may comprise a roller device 1550.

In detail, a plurality of rollers are provided above or below or both above and below the fiber reinforcing member 1090, so that the curvature of the fiber reinforcing member 1090 to be drawn can be controlled by varying the sizes of the rollers or by adjusting the rotating force of the rollers. For example, as shown in FIG. 8, a curved panel can be drawn by setting the rollers such that the rpm of the upper roller is higher than that of the lower roller. Furthermore, a curved panel can be drawn by constructing the roller such that the size of the upper roller is greater than that of the lower roller.

In this case, because constant force is applied to the upper and lower surface of the fiber reinforcing member 1090, the thickness of the fiber reinforcing member 1090 can be maintained constant, and stress is evenly applied to the fiber reinforcing member 1090.

Such rollers 1550 may be used in the forming unit, which bends the fiber reinforcing member 1090 into a curved shape. That is, the forming unit is constructed in the same manner as the above-mentioned structure, and a planar fiber reinforcing member 1090 is processed through the forming unit. Then, the planar fiber reinforcing member 1090 is bent into a curved shape by the difference between speeds at which the upper and lower rollers 1550 rotate.

Meanwhile, referring to FIGS. 1 through 3, the fiber reinforcing member 1090 of the present invention may further include a reinforcing sheet 1700.

In detail, in each of FIGS. 1 through 3, a step, in which a reinforcing sheet 1770 is attached to the fiber reinforcing member 1090, may be additionally conducted before the fiber reinforcing member 1090 passes through the second forming part 1320, 1320, 1320″, such that the reinforcing sheet is integrally hardened with the fiber reinforcing member 1090.

The reinforcing sheet 1700 serves to reinforce the characteristics of the curved panel. Any kind of reinforcing sheet, for example, a sheet for thermal/fire resistance, a sheet for surface treatment, a sheet for reinforcement, etc., may be used. Of course, paint for thermal/fire resistance, for surface treatment or for reinforcement may be applied to the surface of the curved panel to reinforce the characteristics thereof.

Below, the forming unit and the reinforcing sheet of FIG. 2 will be described in detail with reference to FIG. 9.

The reinforcing sheet 1700 is supplied from the outside to the fiber reinforcing member 1090, which is shaped by the first forming part 1310′. Thereafter, the fiber reinforcing member 1090, which is provided with the reinforcing sheet 1700, is secondarily shaped by the second forming part 1320′ into a curved shape. The secondarily shaped fiber reinforcing member 1090 is hardened by the hardening part 1330′ and is drawn forward. At this time, it is preferable that the inner and outer surfaces of the fiber reinforcing member 1090 are heated at a predetermined temperature.

Here, a curved panel which has a cross-section corresponding to the white portion of a sectional view taken along the line B-B of FIG. 10, can be continuously drawn by the structure of the forming unit 1300 shown in FIG. 9. A part of a sectional view of the line A-A is provided on one end of the forming unit and serves to hold parts, which are disposed at the center portion in the sectional view of the line B-B and are separated from the perimeter part of the sectional view of the line B-B.

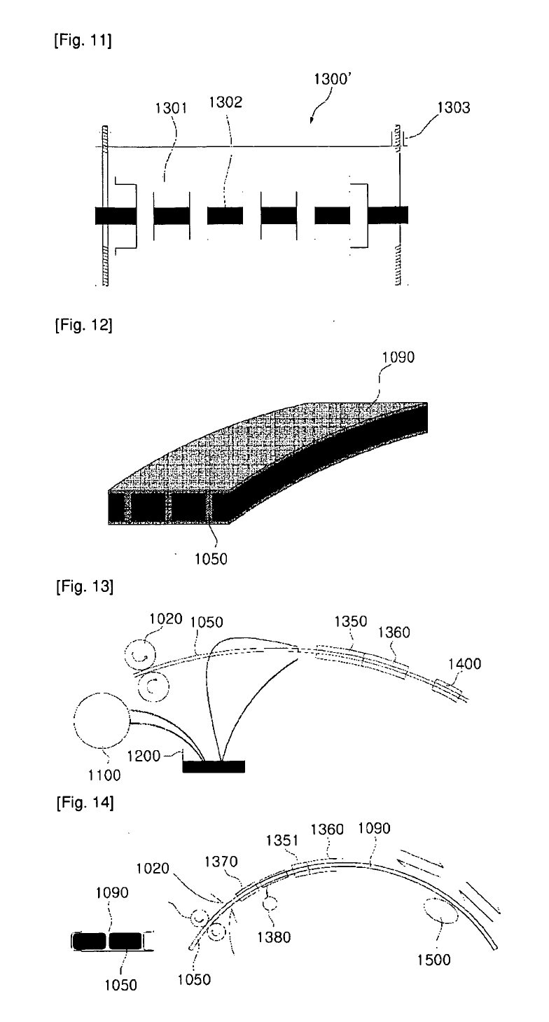

Furthermore, FIG. 11 illustrates the structure of the forming unit 1300, which is constructed such that it is not required to prepare several kinds of forming units corresponding to various sizes of fiber reinforcing members. Thanks to such a structure, only one kind of forming unit 1300, for example one mold having a single body, can form fiber reinforcing members 1090 having various thicknesses, as long as they have the same width. The forming unit 1300′ has a plate 1301, which is placed at the central portion. An insert plate 1302 is supported by bolts 1303.

Meanwhile, as shown in FIG. 12, a curved panel may be manufactured so as to have a structure in which at least one core 1050 is formed in a fiber reinforcing member 1090 when the fiber reinforcing member 1090 is produced.

The core 1050, which is disposed in the fiber reinforcing member 1090, besides conducting an insulation function, serves to prevent the material of the fiber reinforcing member 1090 from being skewed to one side when shaping the fiber reinforcing member 1090 into a curved shape, thus maintaining the shape of the fiber reinforcing member 1090 constant.

Here, the core 1050 is preferably made of a member, which is used as an insulation material, or a member, which is easily formed into a curved shape through an extrusion process, an injection process, a casting process or other method. When a high-strength core 1050 is required, the cores 1050 may be manufactured by a method, in which resin is applied to the surface of the core 1050 before it is hardened.

The core 1050 may have a hollow cross-sectional structure or, alternatively, may have a solid cross-sectional structure. Particularly, the core may be formed by coupling two members, each of which has a ‘U’-shaped cross-section, to each other to have a square cross-section, thus avoiding a difficulty that may occur in the extrusion or injection process.

Therefore, as shown in FIG. 13, in the case where the curved panel is manufactured by applying the fiber reinforcing member 1090 to the outer surface of the core 1050 and by processing them through the forming process, the drawing process and the cutting process, the form of the fiber can be maintained constant when being drawn, and the curved panel can exhibit the insulation effect.

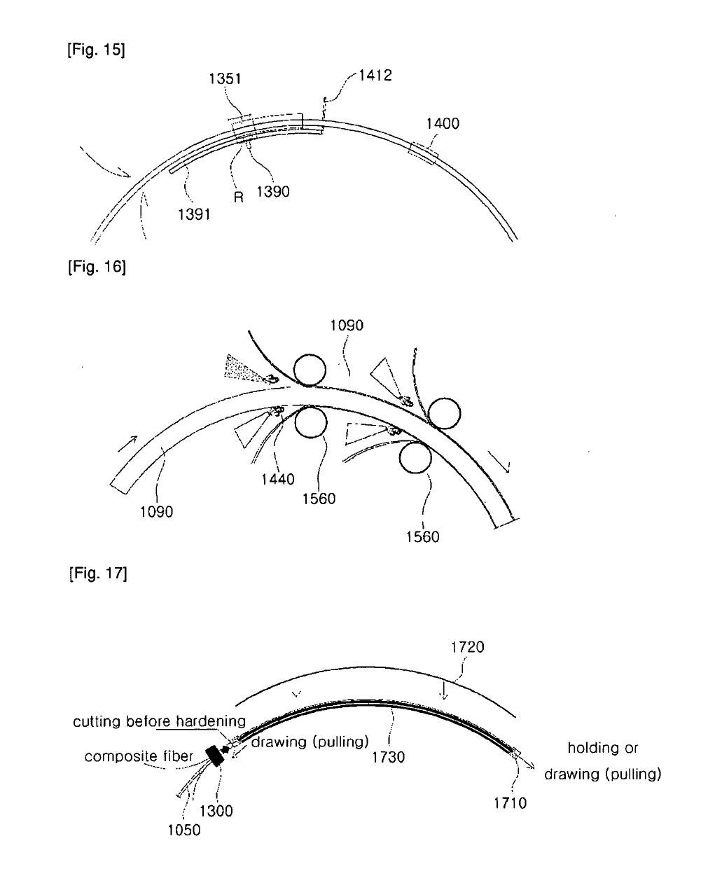

Furthermore, as shown in FIG. 14, in the forming unit 1300, a curved surface forming mold 1351 may be constructed such that it is stationary at a predetermined position. Alternatively, as shown in FIG. 15, the curved surface forming mold 1351 may be constructed such that it is movable along the stationary fiber reinforcing member 1090.

Referring to FIG. 14, depending on the intended purpose of the fiber reinforcing member 1090, a curvature radius of the curved member to be produced may be varied. In the present invention, various kinds of fiber reinforcing members 1090 having different curvature radii can be produced merely by changing the curved surface forming mold 1351′.

To reduce friction between the curved surface forming mold 1351 and the fiber reinforcing member 1090, it is preferable that the curved surface forming mold 1351 comprise several relatively short molds, which are arranged in series, so that the curved shape of the fiber reinforcing member is maintained and friction therebetween is reduced.

Referring to FIG. 15, when the fiber reinforcing member 1090 is drawn into a curved shape, the member may be undesirably deformed by a difference in drawing force between the upper and lower surfaces of the member. To prevent this problem, the present invention may be constructed such that, when the fiber reinforcing member 1090 is being drawn, the fiber reinforcing member 1090 is stationary and the curved surface forming mold 1351 is moved along the fiber reinforcing member, that is, along a curved surface thereof.

Meanwhile, referring to FIG. 16, in the case where a curved panel having a plurality of reinforcing sheets 1700 is manufactured using a round core 1050, which is provided with a fiber reinforcing member 1090, in the step of attaching the reinforcing sheets 1700, 1700′ to the round core, heat is supplied from a heat generator 1440 thereto. Thereafter, the round core is compressed by compressing rollers 1560 and is simultaneously drawn by the compressing rollers 1560.

In the curved panel manufactured by the above-mentioned method, because the curved panel is cut by the cutting part, the ends thereof can be smoothly cut. However, in the case where it is necessary to couple the curved panels to each other, each curved panel needs to have a composite structure. Therefore, a manufacturing step for such post-processing is additionally required.

A post-processing device for this will be explained with reference to FIG. 17. The post-processing device includes an end forming mold 1710, which is used at each of the opposite ends of the fiber reinforcing member 1090 that passes through the forming unit 1300, thus forming a composite structure, and upper and lower molds 1720 and 1730, which are respectively applied to the upper and lower surfaces of the fiber reinforcing member 1090 and have predetermined curvature radii.

Therefore, just after the fiber reinforcing member 1090 is drawn from the forming unit 1300, an already cut end thereof is inserted into the corresponding end forming mold 1710. In this state, the fiber reinforcing member 1090 is further drawn, placed on the lower mold 1730 and simultaneously cut. Subsequently, this newly cut end of the fiber reinforcing member is inserted into the remaining end forming mold 1710. Thereafter, the upper mold 1720 compresses downwards. At this time, the fiber reinforcing member 1090 is drawn in opposite directions, and the composite structures are formed on the opposite ends thereof by the end forming molds 1710.

Below, the method of manufacturing the curved panel using the curved panel manufacturing apparatus having the above-mentioned construction will be explained in detail.

As shown in FIG. 1, the fiber supply unit 1100 supplies fiber. The resin supply unit 1200 supplies to resin to the supplied fiber. Thereby, a fiber reinforcing member 1090 is formed.

Here, before fiber is completely formed, the fiber may be embedded in the resin. Alternatively, after fiber is formed, the formed fiber may be applied to and embedded in resin.

Furthermore, fiber may be embedded in resin by a method, by which after the fiber is formed, the formed fiber is inserted into the first forming part 1310 and a predetermined amount of resin is injected into the first forming part 1310 using a pump 1380 (refer to FIG. 11).

After the fiber of the fiber reinforcing member 1090 has been embedded in resin through the above-mentioned method, the forming unit 1300 shapes and hardens the fiber reinforcing member 1090, and the drawing unit 1400 continuously draws the fiber reinforcing member 1090. The cutting part cuts the fiber reinforcing member 1090.

Referring to FIG. 1, the first forming part 1310 primarily shapes the fiber reinforcing member 1090. The first hardening part 1330 primarily hardens the primarily shaped fiber reinforcing member 1090. The second forming part 1320 secondarily shapes the primarily hardened fiber reinforcing member 1090 through the method of bending it into a curved shape. The second hardening part 1340 secondarily hardens the secondarily shaped fiber reinforcing member 1090 to maintain the curved shape.

In other words, the fiber reinforcing member 1090 is primarily shaped into a planar shape and then the primarily shaped fiber reinforcing member 1090 is primarily hardened. The primarily hardened fiber reinforcing member 1090 is secondarily shaped such that it is bent into a curved shape. The secondarily shaped fiber reinforcing member 1090 is secondarily hardened and then the secondarily hardened fiber reinforcing member 1090 is drawn into a curved shape using the rollers 1020 and is thereafter cut.

Alternatively, as shown in FIG. 2, the curved panel may be manufactured by the method in which the first forming part 1310′ primarily shapes the fiber reinforcing member 1090 into a curved shape, the second forming part 1320′ secondarily shapes the primarily shaped fiber reinforcing member 1090 into a curved shape, and the hardening part 1330′ heats and hardens the secondarily shaped fiber reinforcing member 1090.

In other words, the fiber reinforcing member 1090 is primarily shaped such that it is bent into a curved shape. The primarily shaped fiber reinforcing member 1090 is secondarily shaped such that it is bent into a curved shape. The secondarily shaped fiber reinforcing member 1090 is hardened. Thereafter, the hardened fiber reinforcing member 1090 is drawn by the drawing unit 1400 and is thereafter cut.

As a further alternative, as shown in FIG. 3, the curved panel may be manufactured by the method, in which the first forming part 1310″ primarily shapes the fiber reinforcing member 1090 into a curved shape, and the second forming part 1320″ secondarily shapes the primarily shaped fiber reinforcing member 1090 into a curved shape and simultaneously hardens it.

In other words, the fiber reinforcing member 1090 is primarily shaped such that it is bent into a curved shape. The primarily shaped fiber reinforcing member 1090 is secondarily shaped into a curved shape and is simultaneously hardened. Thereafter, the hardened fiber reinforcing member 1090 is drawn by the drawing unit 1400 and is thereafter cut.

Meanwhile, the shaping of the fiber reinforcing member 1090 into a curved shape can be realized by passing it through a round mold or by bending or drawing it using the roller device 1550 of FIG. 8. Alternatively, the fiber reinforcing member 1090 may be bent by combination of the above two methods.

Meanwhile, as well as the roller device 1550, the drawing unit shown in FIGS. 4 through 6 or the endless track device 1500 of FIG. 7 may be selectively used as the drawing unit 1400. In addition, any device may be used as the drawing unit 1400, as long as it can draw the fiber reinforcing member into a curved shape through a continuous shaping process.

Here, before the fiber reinforcing member 1090 passes through the second forming part 1320, 1320′, 1320″ of each of FIGS. 1 through 3, the step of attaching reinforcing sheets 1700 for thermal/fire resistance, for surface treatment or for reinforcement of the fiber reinforcing member 1090 may be conducted to reinforce the characteristics of the fiber reinforcing member 1090. Thus, the reinforcing sheets can be integrally hardened with the fiber reinforcing member.

Meanwhile, as shown in FIG. 12, at least one pre-processed core 1050 having a curved shape may be provided in the fiber reinforcing member 1090 to prevent the fiber reinforcing member 1090 from being undesirably deformed when it is drawn. This is because, in this case, drawing force is applied to the core 1050, and although the fiber reinforcing member 1090 is relatively thick, the thickness thereof can become even.

A method of disposing the core 1050 in the fiber reinforcing member 1090 will be explained herein below with reference to FIG. 13.

Fiber is supplied from the fiber supply unit 1100. The supplied fiber is embedded in resin in the resin supply unit 1200 to form the fiber reinforcing member 1090 and is supplied to the forming mold 1350. At this time, the core 1050 having a curved shape is supplied into the fiber reinforcing member 1090 before being supplied to the forming mold 1350. The fiber reinforcing member 1090 containing the core 1050 is shaped by the forming mold 1350 and is hardened while passing through a heating room 1360. Subsequently, the fiber reinforcing member is drawn by the drawing unit 1400 into a curved shape and is discharged outside the manufacturing apparatus.

Referring to FIG. 14, the core 1050 is processed before the fiber passes through the forming process. As such, the pre-processed core 1050 is supplied by rollers 20 to a fiber forming mold 1370. At this time, fiber is supplied to the outer surface of the core 1050 before it is supplied to the fiber forming mold 1370.

Thereafter, an appropriate amount of resin is injected into the fiber forming mold 1370 using the pump 1380 such that the fiber and core are embedded in the resin, thus forming the fiber reinforcing member 1090. The fiber reinforcing member 1090 is shaped by the curved surface forming mold 1351 and is continuously drawn by the endless track device 1500.

Here, as shown in FIG. 14, the curved surface forming mold 1351 may have a stationary structure.

Referring to FIG. 14, the present invention can produce various fiber reinforcing members having different curvature radii depending on the intended purposes. In other words, a curvature radius of a fiber reinforcing member to be produced can be varied merely by changing the curved surface forming mold 1351.

Alternatively, as shown in FIG. 15, the curved surface forming mold 1351 may be constructed such that it is moved in the direction in which the fiber reinforcing member 1090 is moved.

In detail, referring to FIG. 15, the fiber reinforcing member 1090 may be undesirably deformed by a difference in drawing force between the upper and lower surfaces of the member when the fiber reinforcing member 1090 is drawn into a curved shape. Therefore, to prevent this, the curved surface forming mold 1351 may draw the fiber reinforcing member 1090 while the fiber reinforcing member 1090 is stationary.

In this case, a separate guide rail 1391 is provided. The curved surface forming mold 1351 moves along the guide rail 1391 to draw the fiber reinforcing member 1090 with a constant force, thereby increasing the precision of the dimensions of the fiber reinforcing member 1090. The fiber reinforcing member 1090 is drawn a predetermined length, and the drawing unit 1400 is operated. Thereafter, the fiber reinforcing member 1090 is held by a holding jack 1412. Subsequently, the curved surface forming mold 1351 is moved along the guide rail 1391 by a drive motor 1390, thus drawing the fiber reinforcing member.

Meanwhile, to apply the reinforcing sheet 1700 to the core 1050 provided with the fiber reinforcing member 1090, as shown in FIG. 16, in the step of attaching the reinforcing sheets 1700 and 1700′ to the round core 1050, heat is supplied thereto from the heat generator 1440 , and the round core is compressed by the compressing rollers 1560, such that the compressing operation and the drawing operation can be conducted at the same time by the compressing rollers.

Furthermore, in the case where it is required to form special coupling structures in the respective opposite ends of the manufactured fiber reinforcing member 1090, the manufacturing step of FIG. 17 may be conducted as post-processing.

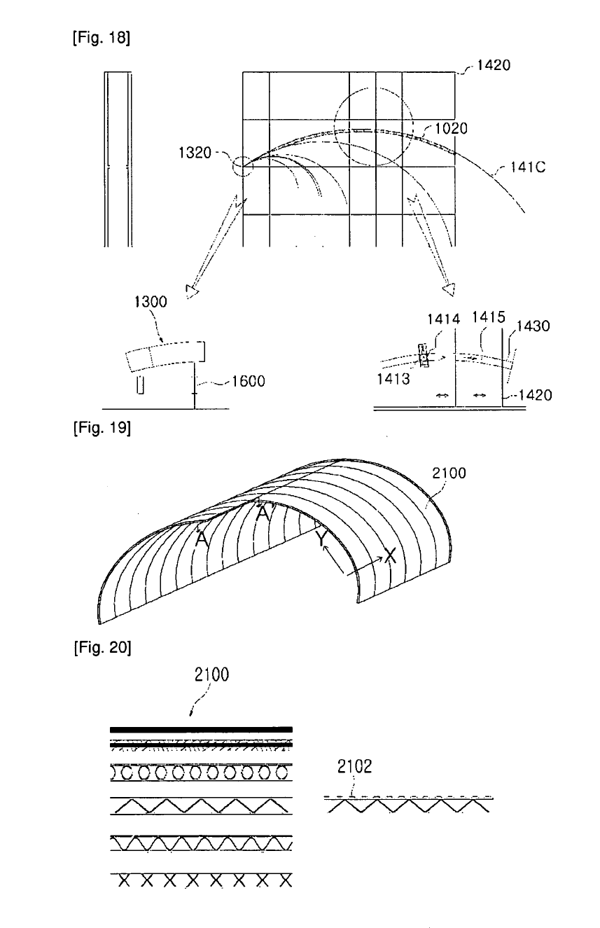

Referring to FIG. 18, the present invention may be constructed such that the forming unit 1300 is adjustable in height, and the heights at which the guide walls 1410 are supported by the guide wall supports 1420, are adjustable depending on the curved shape of the fiber reinforcing member 1090. Thus, as shown in FIG. 12, the fiber reinforcing member 1090 can be drawn along various paths depending on the curved shape.

Here, the forming unit 1300 is connected at one end thereof to an angle adjusting device 1600 which serves to adjust the height of the end of the forming unit 1300.

Thanks to this structure, as well as coping with a round-shaped fiber reinforcing member 1090 which may have a length of several tens of meters, a single manufacturing space for coping with all kinds of fiber reinforcing members 1090 having various curved shapes can be ensured. That is, because the present invention can cope with a fiber reinforcing member having a relatively small round length in addition to a reinforcing member having a relatively large round length, in the same manufacturing place, all kinds of curved panels having various curved shapes can be produced.

Meanwhile, as shown in FIG. 19, in a curved panel lining according to the present invention to construct an arch-shaped underground structure or an arch-shaped aboveground structure, such as a tunnel, curved panels are arranged such that curved surfaces of the lining extend in the arch direction, thus ensuring the structural stability, reducing construction time, and enhancing economic efficiency.

Referring to FIG. 20, the cross-section of the curved panel lining of the present invention has a multi-layered structure. That is, the curved panel lining is formed by adhering two or more panels having different properties to each other. Each lining member 2100 may have a polygonal cross-section in the longitudinal direction (in the direction of Y). Alternatively, the lining member 2100 may have a circular cross-section in the longitudinal direction. As a further alterative, the lining member 2100 may have both a polygonal cross-section and a circular cross-section. The shape of the cross-section of the lining member 2100 is determined depending on the shape of a mold used to manufacture the lining member 2100.

Furthermore, adhesion protrusions 2102 may be provided on the outer surface of the lining member 2100. When back filling on the rear surface of the lining member is conducted, the adhesion protrusions 2102 serve to increase adhesive force between the lining member and the back-filling material and increase shearing resistance, thus facilitating the integration therebetween.

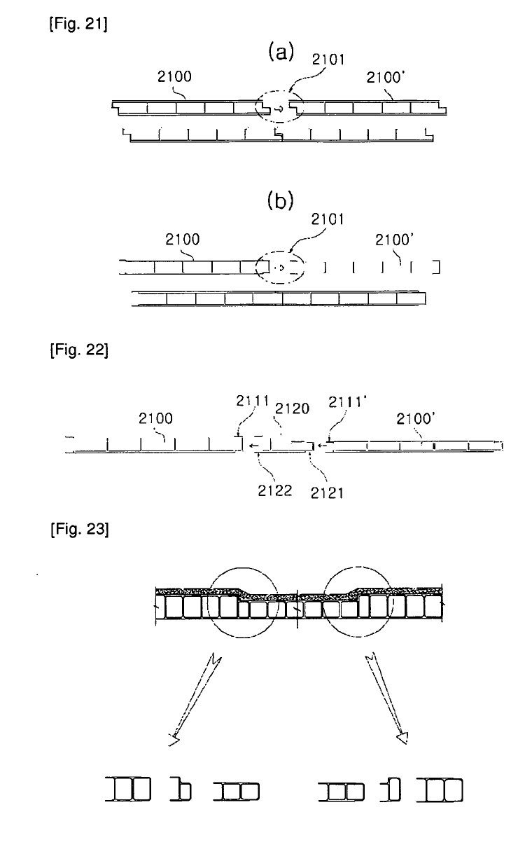

Referring to FIG. 21, the coupling structure between the adjacent curved panel linings with respect to the lateral direction (the direction of X) is realized by the coupling between corresponding protrusions 2101, which are provided on one lining member 2100 and the other lining member 2100′. In views of (a) and (b) of FIG. 19, several coupling types between the protrusions 2101 are illustrated, in which the case of (a) illustrates a method in which they are coupled to each other by engagement, and the case of (b) illustrates a method in which they are coupled to each other by insertion.

Referring to FIG. 21, in the case where it is necessary to couple lining members 2100 and 2100′ having different thicknesses to each other depending on the conditions of an interior of a tunnel (not shown), a separate extension member 2120 may be used.

The extension member 2120 has a predetermined length. A first coupling protrusion 2121 and a first coupling hole 2122 are formed on the respective opposite edges of the extension member 2120. Furthermore, a second coupling protrusion 2111, which is fitted into the first coupling hole 2122, is provided on one edge of the lining member 2100. A second coupling hole 2111′, into which the first coupling protrusion 2121 is fitted, is formed in a corresponding edge of the other lining member 2100′.

Therefore, the lining members 2100 and 2100′ having different thicknesses can be coupled to each other using the extension member 2120.

For example, the relatively thick lining member 2100 is used in a place where a base rock is unstable or a surface load is large in a cut-and-cover tunnel so that a relatively large stress is applied to the lining member. The relatively thin lining member 2100′ is used in a place where a base rock is stable or a surface load is small in the cut-and-cover tunnel so that a relatively small stress is applied to the lining member. Here, because the lining member 2100 and the lining member 2100′ are connected to each other in the tunnel using the extension member the inner surfaces of the lining members can be smoothly flushed.

FIG. 23 illustrates several examples of extension members for coupling the lining members, having different thicknesses depending on loads applied to each of the lining members.

Meanwhile, the curved panel lining of the present invention includes a plurality of lining members 2100, each of which has a predetermined length and is curved with respect to the longitudinal direction thereof, and a connection means 2200, which couples the lining members 2100 to each other in the longitudinal direction.

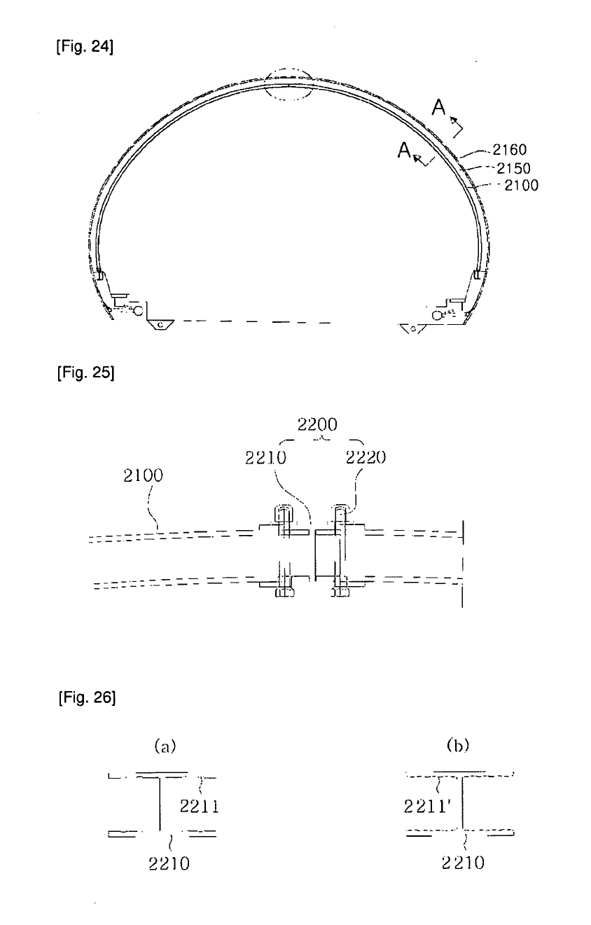

Referring to FIG. 24, the curved panel lining members 2100 of the present invention are arranged along the arch-shaped inner surface of the tunnel. Several, preferably two, lining members 2100 are coupled to each other in the longitudinal direction. At this time, a shotcrete 2160 is constructed around the circumferential outer surfaces of the lining members 2100. A gap 2156 may be defined between the lining members 2100 and the shotcrete 2160.

As shown in FIGS. 25 through 32, the lining members 2100 can be coupled to each other in the longitudinal direction by various kinds of connection means 2200.

Below, embodiments of the connection means 2200 according to the present invention will be explained with reference to FIGS. 25 through 32.

Referring to FIG. 25, the connection means 2200 may include a coupling member 2210, which covers the surfaces of the facing ends of the adjacent lining members 2100, and coupling bolts 2220, which couple the coupling member 2210 to the lining members 2100. Therefore, the coupling member 2210 is interposed between the lining members 2100 and thus couple the lining members 2100 to each other using the coupling bolts 2220. A cap nut, which is fitted over the end of each coupling bolt 2220, may be provided on the outer surface of the lining member 2100.

As shown in FIG. 26, uneven surfaces 2211 or 2211′ may be formed in the corresponding surfaces of the coupling member 2210 and the lining members 2100. The uneven surfaces 2211 or 2211′ are formed in the contact surfaces between the coupling member 2210 and the lining members 2100, thus serving to lock the contact surfaces to each other.

Each uneven surface 2211 may be formed by rectangular grooves 2211, as shown in

FIG. 25a, or by triangular protrusions 2211. Of course, curvilinear protrusions, such as wave-shaped protrusions, may be used to form the uneven surface 2211, although this is not shown in the drawings.

In the case where it is difficult to use only adhesion means because a relatively large coupling force is required, such coupling using the above protrusions may be used in place of the coupling using the adhesion means, or the use of protrusions is combined with the use of the adhesion means.

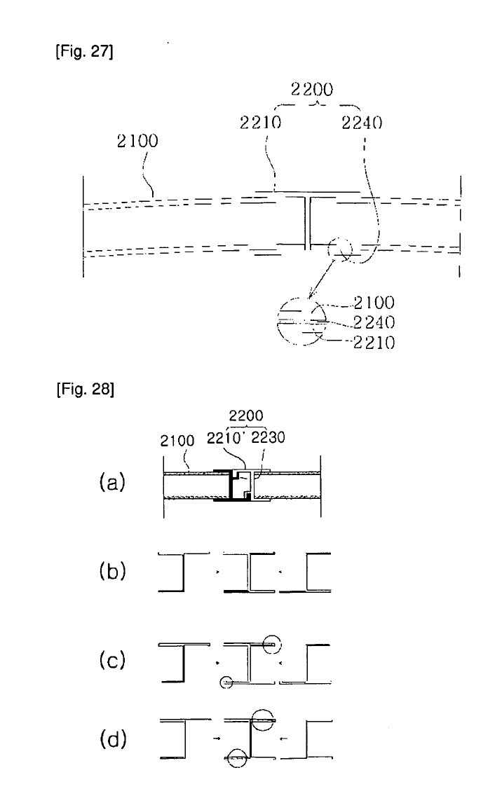

Referring to FIG. 27, the coupling member 2210 and the lining members 2100 may be coupled to each other by an adhesion means 2240, such as an adhesive applied thereto to provide adhesive force.

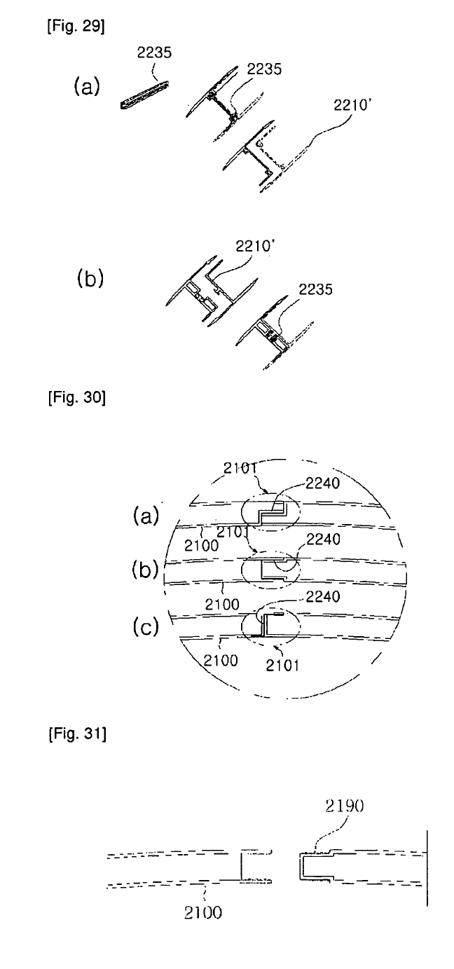

Referring to FIGS. 28 and 29, the connection means 2200 may be coupling members 2210′, which are provided on the respective facing ends of the adjacent lining members 2100. Here, as shown in FIG. 28, the coupling members 2210′ may have respective coupling protrusions 2230, which are locked to each other, such that the coupling members can be firmly coupled to each other. Alternatively, as shown in FIG. 29, a separate coupling insertion 2235 is interposed between the coupling members 2210′ such that they can be more firmly coupled to each other.

Referring to FIG. 30, the connection means 2200 may be coupling protrusions 2101, which are provided on the respective facing ends of the adjacent lining members 2100 and are coupled to each other.

Here, as shown in the views of (a), (b) or (c) of FIG. 30, each coupling protrusion 2101 may have a shape in which the central portion thereof protrudes outwards, or in which the perimeter thereof protrudes outwards and the central portion thereof is depressed inwards, so that the lining members 2100 can be coupled to each other by the coupling between the coupling protrusions.

Furthermore, the adhesion means 2240 may be applied to the contact surfaces between the coupling protrusions 2101.

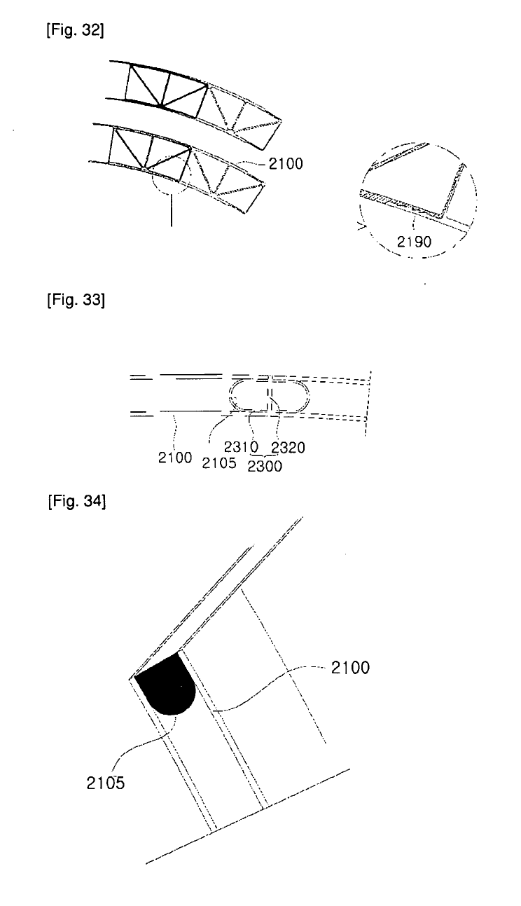

Referring to FIG. 31, in the case where the lining members 2100 are constructed such that they are coupled to each other by the insertion method, uneven surfaces 2190, which engage with each other, may be formed in the respective contact surfaces between the coupling protrusions 2112. Such coupling method can also be applied to the case of FIG. 32, which shows the coupling between the round-shaped lining members 2100.

Referring to FIG. 33, the connection means 2200 may include coupling parts 2105, which are partially or entirely formed on the respective facing ends of the adjacent lining members 2100, and a connection member 2300, which is interposed between the lining members 2100, and the opposite ends of which are coupled to the respective coupling parts 2105.

Each coupling part 2105 may be a depression 2105 which is formed in the corresponding end of each lining member 2100. The connection member 2300 includes a protrusion body 2310, which has a length equal to the width of the lining member 2100 and is inserted at the opposite ends thereof into the respective depressions 2105, and a center body 2320, which is provided in the central portion of the protrusion body 2310 and is disposed between the lining members 2100. The center body 2320 is brought into close contact with the lining members 2100.

Furthermore, as shown in FIGS. 33 and 34, each depression 2105 may have a round inner surface, and each end of the protrusion body 2310 may have a round outer surface corresponding to the round inner surface of the depression 2105 such that they come into close contact with each other.

As such, because the opposite ends of the connection member 2300 have round shapes, they can be easily inserted into the respective coupling parts 2105, which are formed in the respective corresponding ends of the lining members 2100. Therefore, the lining members 2100 can be easily coupled to each other.

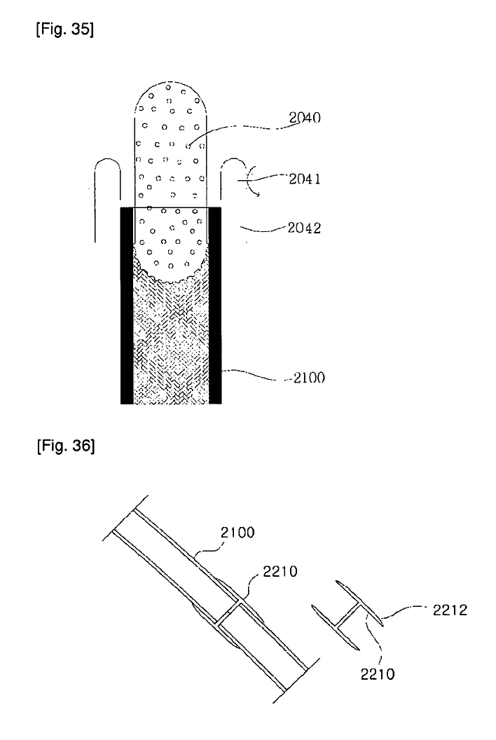

Each coupling part is formed in the corresponding end of each lining member 2100 by depressing the entire area of the end of the lining member 2100 inwards. A cutter for forming such a coupling part is shown in FIG. 35. The cutter includes a cutting bit 2040, which has a shape corresponding to the connection member 2300, a rotating shaft 2041, which is provided through the intermediate portion of the cutting bit 2040, and a support member 2042, which supports the rotating shaft 2041. To form the coupling part in the lining member 2100 using the cutter, a desired end of the lining member 2100 is inserted into the support member 2042. Thereafter, when the cutter is operated, the cutting bit 2040 is rotated by the rotation of the rotating shaft 2041. Then, a depression for forming the coupling part 2105 is formed in the end of the lining member 2100. Through this process, the coupling parts 2105 can be formed in the respective corresponding ends of the lining members 2100 using the cutter.

Meanwhile, FIG. 36 illustrates the coupling member 2210, which is interposed between the lining members 2100. The coupling member 2210 may be configured such that the upper and lower surfaces thereof protrude from the outer surface of the lining members 2100. In this case, the internal space is reduced, or, if the tunnel is an aqueduct tunnel, the coupling member 2210 may impede the flow of water.

Therefore, to prevent these problems, it is preferable that the edges of the upper and lower surfaces of the coupling member 2210 be rounded. That is, in the case where the upper and lower surfaces of the coupling member 2210 are rounded, friction is reduced, and the coupling member 2210 is prevented from being damaged by contact with external substances.

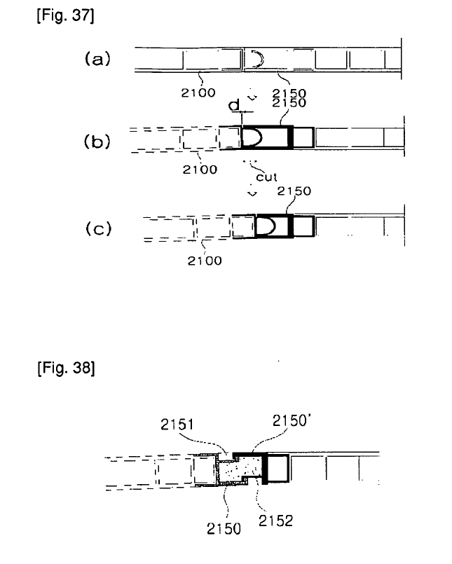

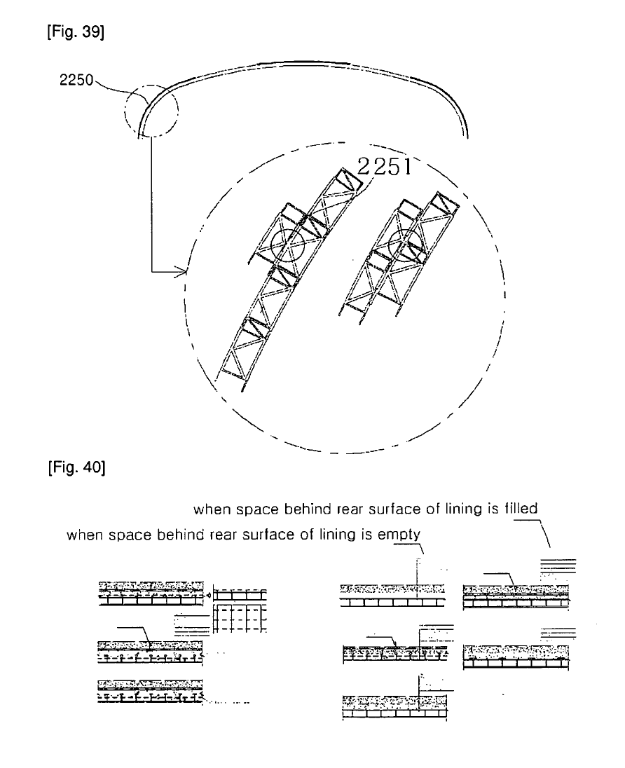

Meanwhile, referring to FIG. 37, when the lining members 2100 are connected to each other, if the longitudinal slope or horizontal alignment is varied from the initial state of (a), it is necessary to compensate for the lengths of upper and lower surfaces of a curved section.

FIG. 37 is a view showing a connector 2150 for coping with the above-mentioned case. The connector 2150 has a predetermined length and is interposed between the adjacent lining members 2100. In addition, the connector 2150 is coupled to the facing ends of the lining members 2100 and may be configured such that the lengths of the upper and lower surfaces thereof differ from each other.

As shown in FIG. 37b, in the case where the upper and lower surfaces of the connector 2150 are different in length, the connector 2150 is preferably oriented such that a relatively short surface thereof becomes an inner surface of the curved section. Thus, when the connector 2150 couples the lining members 2100 to each other at the curved section, a gap ‘d’ is defined in the upper surface thereof, so that the lining members 2100 can be angled relative to each other at a predetermined angle.

As shown in FIG. 37c, if it is required to reduce the length of the connector 2150, the connector 2150 is cut, for example, by a length designated as ‘cut’, using a cutting device (not shown). As such, in the case where the lining members 2100 are connected to each other using the connector 2150, which is reduced in length, the entire length of the lining members 2100 can be reduced.

Meanwhile, referring to FIG. 38, two connectors 2150 and 2150′ may be provided such that a first space 2151, into which insert material is inserted, and a second space 2152, which is connected to the first space 2151 and is filled with reinforcing material, are defined between the connectors 2150 and 2150′. In this case, compensation for the difference in lengths between the upper and lower surfaces of the curved section can be realized by the insertion of the insert material in a state in which the reinforcing material is charged into the second space.

Here, hardened fiber reinforcing material may be used as the insert material. A mixture of resin and foaming agent, concrete, foaming concrete or foamed adiabatic material may be used as the reinforcing material.

Preferably, after the insert material is charged into the first space 2151 using a resin injection hose, the upper part thereof is covered with a fiber reinforcing sheet for finishing.

Referring to FIG. 40, in the case of a tunnel or other arch structure where a relatively large force is partially applied thereto, if a lining extends the entire length of the cross-section thereof, economic efficiency is reduced. Therefore, it is preferable that a lining for reinforcing be provided only in a portion to which a relatively large stress is applied. For this, reinforcing panels 2250 are partially provided only on those portions to which relatively large stress is applied.

The installation of the reinforcing panels 2250 may be realized by applying an adhesive means to the desired portions but, more preferably, the reinforcing panels 2250 may be installed by an engagement coupling method using reinforcing protrusions and depressions 2251.

Such reinforcement using the panels may be applied between curved panel lining members, between typical linear plate lining members, each of which has a partial round cross-section and a linear section of a predetermined length, or between a curved panel lining member and a linear plate lining member.

Referring to FIG. 40, in the present invention, the curved panel lining may be combined with concrete. In the case of a typical concrete lining, it takes three to five days to cast concrete after constructing a steel mold. However, as described above, in the case where a lining is constructed instead using the curved panels combined with concrete, there is an advantage in that construction time is markedly reduced, because it is not required to move and construct the steel mold and cure concrete.

Below, a curved panel construction method according to the present invention will be described.

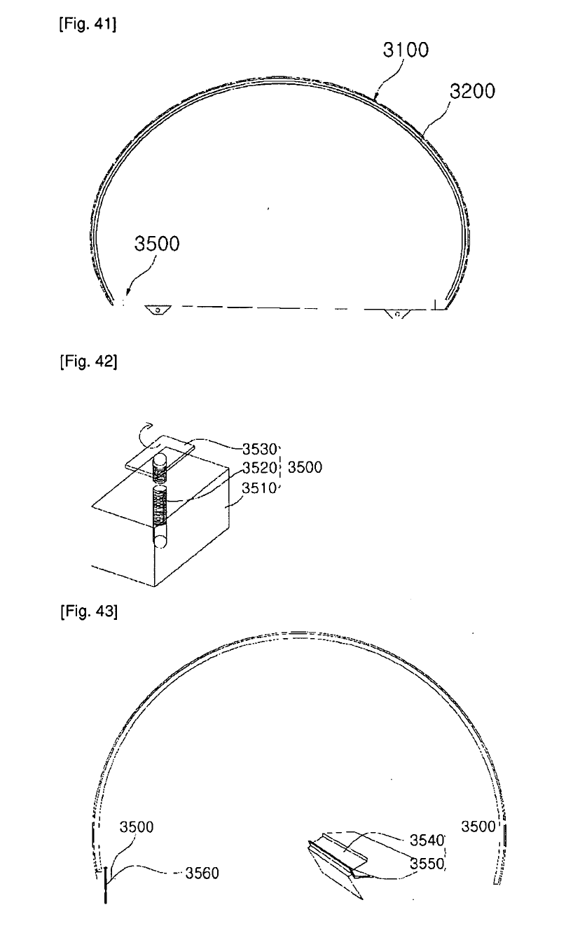

Referring to FIG. 41, first, curved panels 3200 having predetermined lengths are prepared in accordance with an arch shape of an arch structure. A tunnel 3100 to be provided with the curved panels 3200 is bored. Thereafter, the curved panels 3200 are installed in the bored tunnel 3100. In the case of a cut-and-cover structure, the ground is leveled, and curved panels are thereafter installed on the leveled ground.

The curved panel construction method of the present invention is classified into two kinds of methods.

As a first method, in the case where a surface load is relatively large due to an unstable base rock or a rapid construction for a cut-and-cover structure is required, just after a tunnel 3100 is bored, curved panels 3200 are installed in the tunnel 3100.

As a second method, in the case where a surface load is relatively low due to a stable base rock, after a predetermined time has passed since the tunnel 3100 is bored, the curved panels 3200 are installed in the tunnel 3100.

The first construction method will be explained herein below.

In the first construction method, the time provided to install a concrete structure for supporting the curved panels 3200 in the tunnel 3100 is insufficient.

Therefore, precast panel supports 3500 are arranged in the tunnel 3100 in the longitudinal direction of the tunnel 3100. After the curved panels 3200 are supported by the precast panel supports 3500, the precast panel supports 3500 are covered with concrete at one time, thus finishing the lower structure of the tunnel.

As shown in FIG. 42, each precast panel support 3500 may include a height adjusting device on the upper end thereof. The height adjusting device includes a screw bolt 3520, which is provided in an upper end of a support body 3510 so as to be movable upwards or downwards using the rotation thereof, and a planar plate 3530, which is provided on the upper end of the screw bolt 3520. The planar plate 3530 serves to support the corresponding curved panel 3200 thereon.

Due to this structure, the heights at which the curved panels 3200 are installed can be adjusted by the rotating operation of the screw bolts 3520.

Meanwhile, FIG. 43 illustrates another precast panel support 3500′. This precast panel support 3500′ includes an inclined part 3540, which comes into close contact with and thus supports the lower ends of the curved panels 3200, and a support blade 3550, which prevents the curved panels 3200 from slipping downwards. Such a precast panel support 3500 is fixed to the ground using locking bolts 3560.

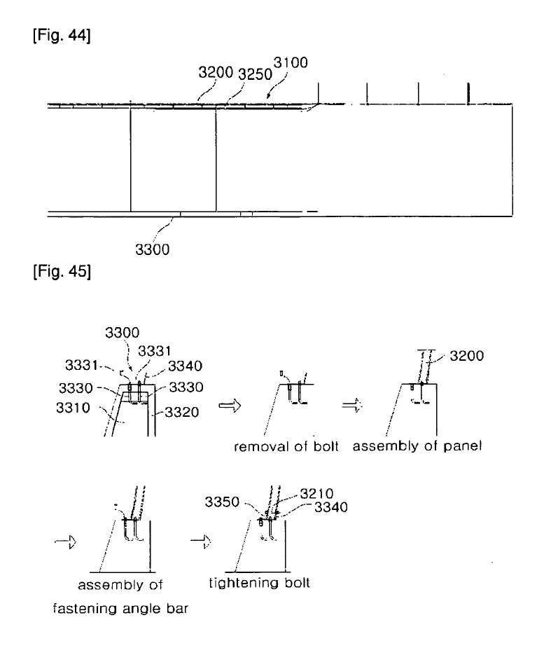

Here, as shown in FIG. 44, panel protectors 250, which are arranged along the bored tunnel 3100, may be provided on the inner surfaces of the curved panels 3200, thus protecting the curved panels 3200 from broken pieces or impact generated during the construction process.

Next, the second construction method will be explained.

In the second construction method, after a predetermined time has passed since a tunnel 3100 is bored, the curved panels 3200 are installed. In this case, the time sufficient to manufacture and install concrete structures 3300 of FIG. 44 in the tunnel 3100 is ensured.

Therefore, in this construction method, after the concrete structures are installed in the tunnel 3100, the curved panels 3200 are installed in the tunnel 3100 such that they are supported by the concrete structures 3300.

Such concrete structure 3300 will be explained herein below with reference to FIG. 45.

The concrete structure 3300 includes a concrete body 3310, reinforcing bars 3320, which are embedded in the concrete body 3310, and a pair of anchor bolts 3330, which are installed in the upper end of the concrete body 3310. First ends of the anchor bolts 3330 are embedded in the concrete body 3310 and are held by the reinforcing boars 3320, and second ends thereof protrude outwards from the upper surface of the concrete body 3310.

Furthermore, the concrete structure further includes an L-shaped base angle bar 3340, which is coupled to the second end of a corresponding anchor bolt. In addition, a bolt 331 is fastened to the second end of each anchor bolt 3330.

A process of supporting the curved panel 3200 to the concrete structure 3300 having the above-mentioned construction will be explained herein below.

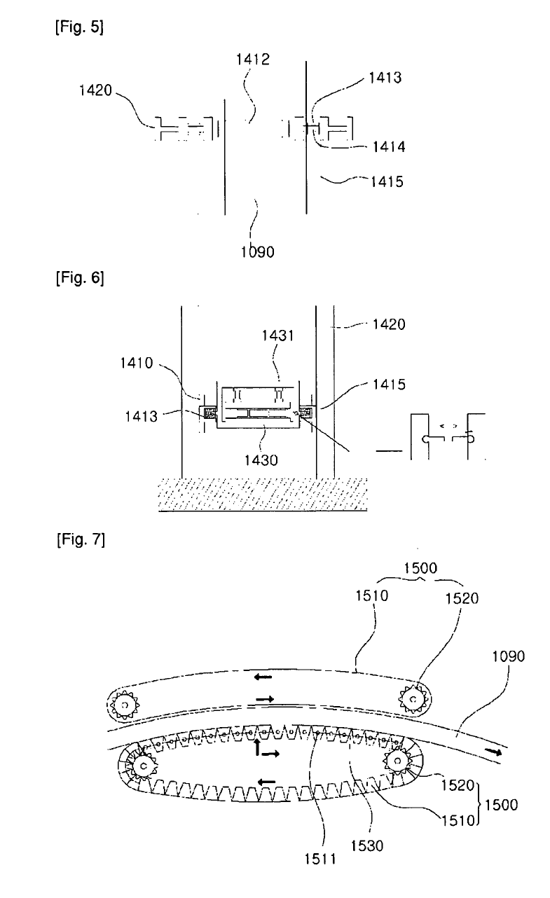

Referring to FIG. 5, the bolts 331 are first removed from the second ends of the anchor bolts 3330. Thereafter, the lower end of the curved panel 3200 is supported by the base angle bar 3340. Subsequently, a fastening angle bar 3350 is coupled to the second end of the anchor bolt 3330 which is distinct from the anchor bolt 3330 provided with the base angle bar 3340. Here, the fastening angle bar 3350 has an L shape. The bolts 331 are fastened to the respective anchor bolts 3330 again.

Then, the lower end of the curved panel 3200 is disposed between the vertical surface of the base angle bar 3340 and the vertical surface of the fastening angle bar 3350. Thereafter, a fastening bolt 210 is fastened through the vertical surfaces of the base angle bar 3340 and the fastening angle bar 3350 to fasten the lower end of the curved panel 3200 to the base angle bar 3340 and the fastening angle bar 3350.

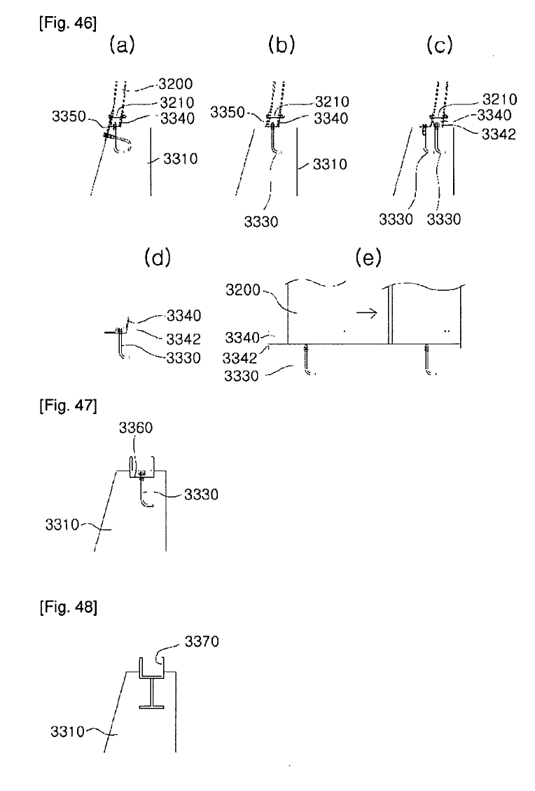

FIGS. 46 through 48 illustrate other methods of supporting the curved panel 3200 by the concrete structure 3300 according to the present invention.

Referring to FIG. 46, in the case of (a), two anchor bolts 3330 are installed in a concrete body 3310 such that the anchor bolts 3330 cross over each other. Furthermore, a fastening angle bar 3350 is provided on a sidewall of the concrete body 3310.

In the case of (b), a fastening angle bar 3350 and a base angle bar 3340 are fastened to an upper surface of a concrete body 3310. The base angle bar 3340 is supported by one anchor bolt 3330, and the fastening angle bar 3350 is fastened to one end of the base angle bar 3340.

The case of (c) is similar to the concrete structure 3300 of FIG. 44, except for a structure in which an anchor bolt 3330, which is disposed between the fastening angle bar 3350 and the base angle bar 3340, has a first guide 3342 disposed therebetween. This structure is shown in detail in the view of (d).

In this case, when the curved panel 3200 is inserted into space between the fastening angle bar 3350 and the base angle bar 3340, the lower end of the curved panel 3200 is prevented from being impeded by the upper end of the anchor bolt 3330. Accordingly, the movement of the curved panel 3200 is illustrated in the view of (e).

Referring to FIG. 47, an anchor bolt 3330 may be installed in a concrete body 3310 such that it partially protrudes from the upper end of the concrete body 3310. A second guide 3360, which is supported by the anchor bolt 3330, may be provided on the upper end of the concrete body 3310. In the same manner as the first guide 342, the second guide 3360 may have a seating hole such that the upper end of the anchor bolt 3330 is prevented from impeding the lower end of the curved panel 3200.

As shown in FIG. 48, a third guide 3370 may be installed in a concrete body 3310 such that a first end of the third guide 3370 is supported by the concrete body 3310 and a second thereof is disposed on the upper end of the concrete body 3310. The bottom of the third guide 3370 is planar, so that the lower end of the curved panel 3200 can be smoothly moved on the bottom of the third guide.

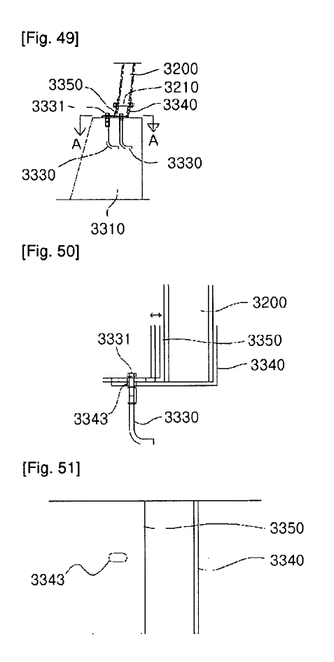

Referring to FIGS. 49 and 50, in a concrete structure 3300 having the structure of FIG. 50, a guide slot 3343, which guides movement of an anchor bolt 3330, is formed through the fastening angle bar 3350.

As shown in FIG. 51, the guide slot 3343, which is formed through the fastening angle bar 3350, extends in the thicknesswise direction of the curved panel 3200 and has an elliptical shape.

As such, because the anchor bolt 3330 is movably placed in the guide slot 3343, the curved panel 3200, which is disposed between the fastening angle bar 3350 and the base angle bar 3340, can be moved in the thicknesswise direction.

Therefore, in the present invention, the curved panels 3200 can be installed in the tunnel 3100 by moving the curved panels 3200 from outside one end of the tunnel 3100.

When moving the curved panels into the tunnel, a wire or a rope may be used, or a jack may be used, although this is not shown in the drawings.

More exactly, the curved panels may be directly moved into the tunnel using a jack. Alternatively, side members may be directly assembled and installed at desired positions. Or, in the case where the tunnel is relatively long, members may be assembled and installed at the central portion in the tunnel.

In addition, while constructing the tunnel, to cope with collapse of a working face or deformation of the upper part of the tunnel, the tunnel may be reinforced by a pre-grouting method or a reinforcing grouting method.

To respond to nonuniform settlement or uneven load, the panel may be filled with concrete for reinforcement.

Meanwhile, the curved panels 3200 may be installed in the tunnel 3100 by a method in which the curved panels 3200 are disposed at different positions in the tunnel 3100 and are thereafter pushed to the inner surface of the tunnel 3100.

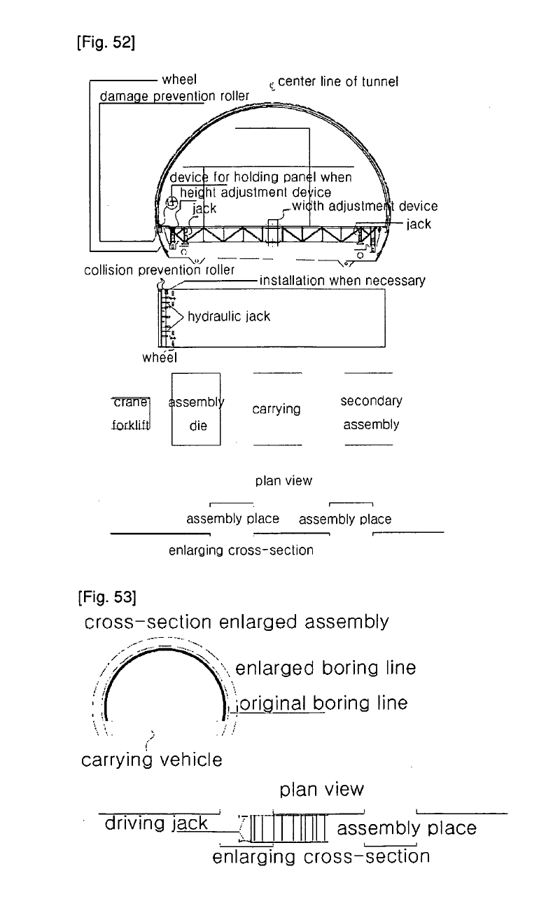

This curved panel installation method will be explained herein below with reference to FIGS. 52 through 57.

The curved panel installation method is classified into methods in which the curved panels are assembled outside the pit formed in the tunnel 3100 and are carried therein, a method in which the curved panels are assembled inside the tunnel 3100 and are carried, and a method in which the curved panels are directly assembled and installed in the inside of the tunnel 3100.

First, the method in which the curved panels are assembled outside the pit of the tunnel 3100 and are carried will be described.

Referring to FIG. 52, the curved panels are carried to an assembly die using a backhoe, a forklift, a small crane, a hydraulic jack, etc. The carried curved panels are primarily assembled on the assembly die. Thereafter, the primarily assembled curved panels are carried to a desired position in the tunnel. Subsequently, a secondary assembly process, in which the curved panels are installed on the inner surface of the tunnel, is conducted.

Next, the method in which the curved panels are assembled inside the tunnel 3100 and are carried will be explained herein below.

Referring to FIG. 53, in the case where the tunnel is very long or a relatively small space is defined behind the rear surface of the curved panels so that it is difficult to assemble the curved panels in the tunnel, the curved panels are first carried to an assembly place in the tunnel. Thereafter, the curved panels are assembled by a cross-section enlarging method.

Here, segments assembled by the cross-section enlarging method, may be moved to an installation position using a hydraulic jack, a rope or a chain.

Next, the method in which the curved panels are directly installed in the pit in the tunnel 3100 will be explained herein below.

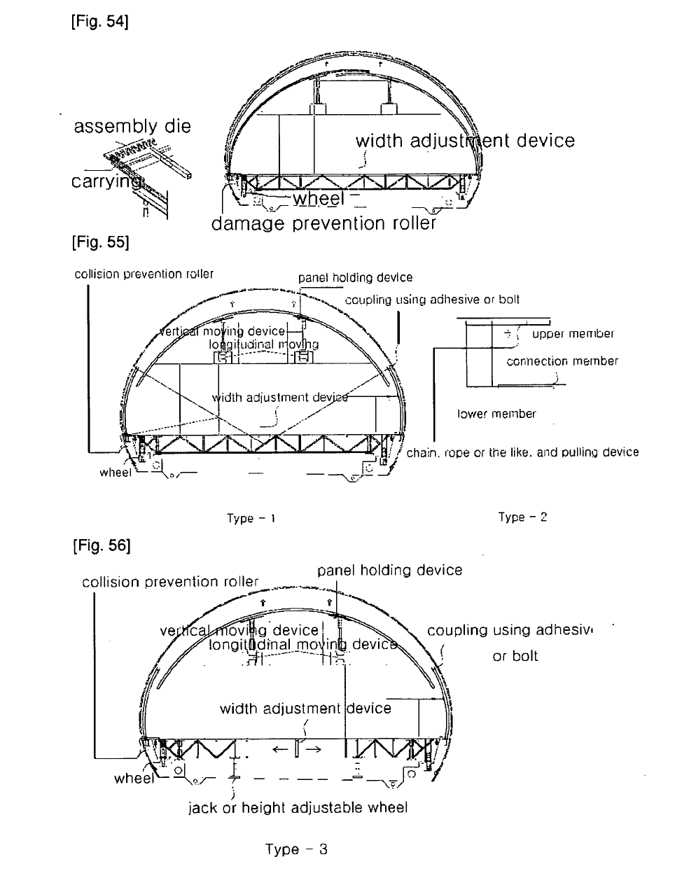

Referring to FIGS. 54 through 57, the curved panels may be directly installed inside the tunnel. Hereinafter, the tunnel is designated by the numeral ‘100’, and the curved panel is designated by the numeral ‘200’.

Referring to FIG. 54, the curved panels 3200 are placed around the upper end of the tunnel 3100 such that they partially overlap each other. Thereafter, the curved panels 3200 are pushed upwards by a vertical moving device and are thus installed on the inner surface of the tunnel.

Referring to FIG. 55, side curved panels 3200 having predetermined lengths are arranged on the opposite sidewalls in the tunnel 3100. Center curved panels 3200 are pushed upwards between the side curved panels towards the ceiling of the tunnel 3100 using a vertical lifting device. As such, the curved panels 3200 can be directly installed in the tunnel 3100.

Referring to FIG. 56, a jack is provided in the lower part of the assembly die such that the height of the assembly die can be adjusted. The side curved panels 3200, which are supported on the opposite ends of the assembly die, are installed on the opposite sidewalls of the tunnel 3100. In the central portion of the assembly die, the center curved panel 3200 is lifted by the vertical lifting device and is thus installed on the ceiling of the tunnel 3100.

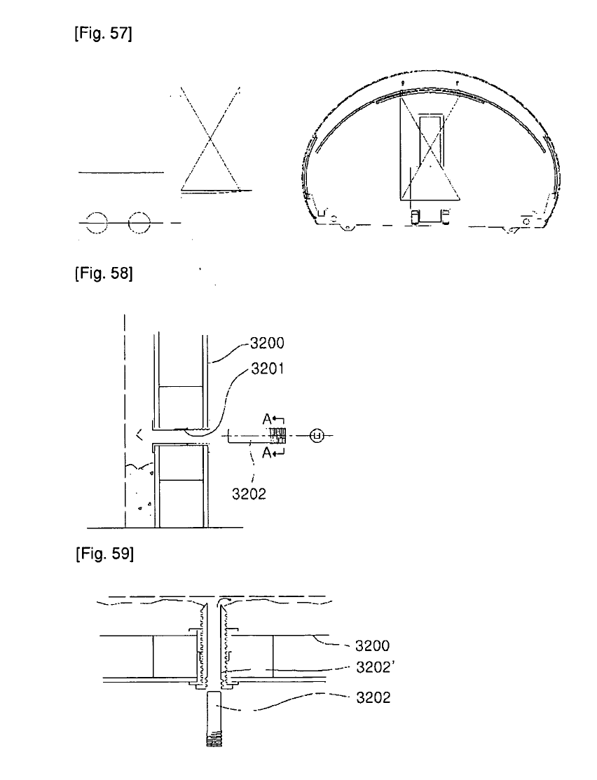

As shown in FIG. 57, in the case where the number of curved panels 3200 to be installed is relatively small, the curved panels 3200 may be loaded on a forklift and moved into the tunnel 3100 to an assembly position, at which they are assembled and installed. At the assembly position, the curved panels 3200 are assembled with each other and installed on the surface of the tunnel 3100.

The above-mentioned curved panels 3200 are preferably connected at opposite ends thereof to each other using adhesive or bolts.

Meanwhile, there may be space between the surface of the tunnel 3100 and the curved panels 3200 which may be empty, or, alternatively, it may be filled with a filler.

Referring to FIG. 58, in this case, an injection hole 3201, through which the filler is injected, is formed through the curved panel 3200. Thus, the filler is charged into the above-mentioned space through the injection hole 3201.

As shown in FIG. 59, the present invention may be constructed such that an internal thread is formed in the injection hole 3201, through which the filler is injected, a hollow bolt 3202 is tightened into the threaded injection hole, and a stop bolt 3202′ is inserted into the hollow bolt 3202 to temporarily close the injection hole 3201.

Elsewise, a gap may be defined between the curved panels 3200 and the inner surface of the tunnel 3100.

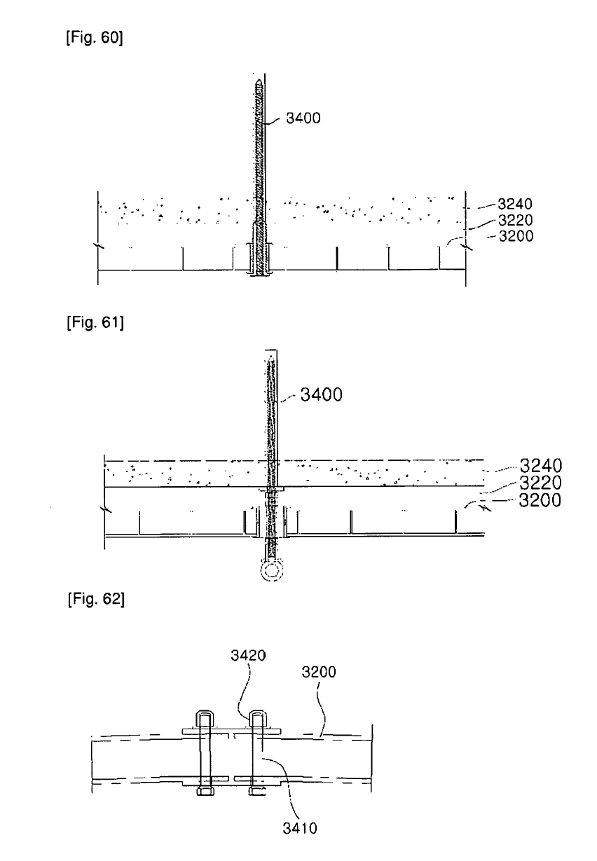

Furthermore, as shown in FIG. 60, the curved panel 3200 may be fastened to the base rock, in which the tunnel 3100 is formed, using a locking bolt 3400. Preferably, the locking bolt 3400 is firmly tightened through the curved panel 3200. In the tunnel 3100, a shotcrete 3240 is provided around the outer surface of the curved panel 3200. A gap 3220 may be defined between the curved panel 3200 and the shotcrete 3240.

The reason for this is that it is uneconomic to use thick panels 3100 in all sections despite application of partial high loads. The shotcrete serves to waterproof and support a load, when back-filling is applied to the rear surface of the curved panel 3200. In addition, the shotcrete serves to integrate the curved panel 3200 with back-filling material and serves as a fixed point in the case where a gap 3220 is defined behind the rear surface of the panel 3200 and when a load is applied to the inner surface of the panel outwards.

Referring to FIG. 61, the locking bolt 3400 may be spaced apart from the curved panel 3200 by a predetermined distance.

In the case where the locking bolt 3400 is in close contact with the curved panel 3200, if the locking bolt 3400 is connected to a device, such as a jet fan, causing vibration, vibration or impact is applied to the curved panels 3200. To cope with this, the locking bolt 3400 may be spaced apart from the curved panel 3200 by a predetermined distance.

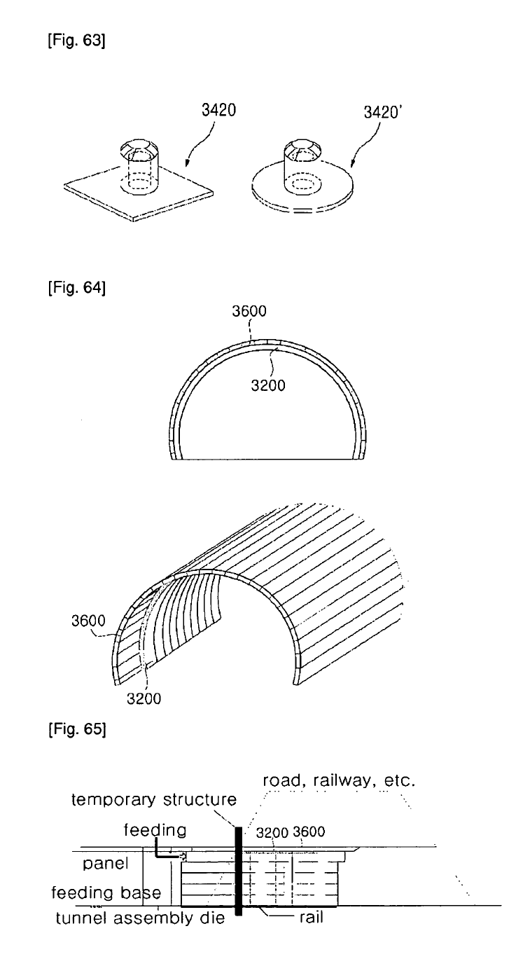

Furthermore, as shown in FIGS. 62 and 63, a cap nut 3420, which is fitted over an end of a coupling bolt 3410, may be provided on the rear surface of the curved panel 3200.

For this, the cap nut 3420 is previously attached to the rear surface of the curved panel 3200 by adhesion or the like at a position corresponding to a bolt hole, which is formed through the curved panel 3200. After a predetermined amount of time has passed after the cap nut 3420 is attached to the curved panel 3200, when the curved panels 3200 are installed in the tunnel 3100, the curved panels 3200 can be more firmly supported with respect to each other by tightening the coupling bolts 3410.

The shape of the cap nut 3420 is shown in FIG. 63. The cap nut 3420 has a planar shape on the lower end thereof. The planar lower end of the cap nut 3420 which contacts the rear surface of the curved panel 3200 may has a rectangular shape or a circular disk shape.

Meanwhile, in the case where the tunnel is formed under an obstruction, as shown in FIG. 64, linear panels 3600, each of which has a round cross-section and a predetermined length and is oriented in the longitudinal direction of the tunnel, are preferably combined with the curved panels 3200.

The construction method using the linear panels will be explained with reference to FIG. 65. The linear panels 3600 are force-fitted into the existing tunnel in the longitudinal direction of the tunnel, thus forming a first lining. Thereafter, the curved panels 3200 according to the present invention are installed in the arch direction of the tunnel, thus forming a second lining, thereby reinforcing the tunnel more reliably.

In detail, the linear panels 3600 may be assembled in a panel feeding base and be supplied into the tunnel or, alternatively, they may be supplied into the tunnel while boring the tunnel to minimize deformation of the base ground. The curved panels 3200 may be assembled with each other outside the tunnel and then moved into the tunnel. Furthermore, the curved panels 3200 may be assembled at the installation position in the tunnel. Thereafter, the tunnel is further bored, and linear panels 3600 are moved into and installed in the tunnel such that they are arranged into a symmetric ring shape. Subsequently, curved panels 3200 are installed in the tunnel. These processes are repeated. Here, the panels are moved and installed in the same manner as the above-stated curved panel moving installing method.

Here, it is preferable that adhesive be charged between the completed first lining and the second lining.

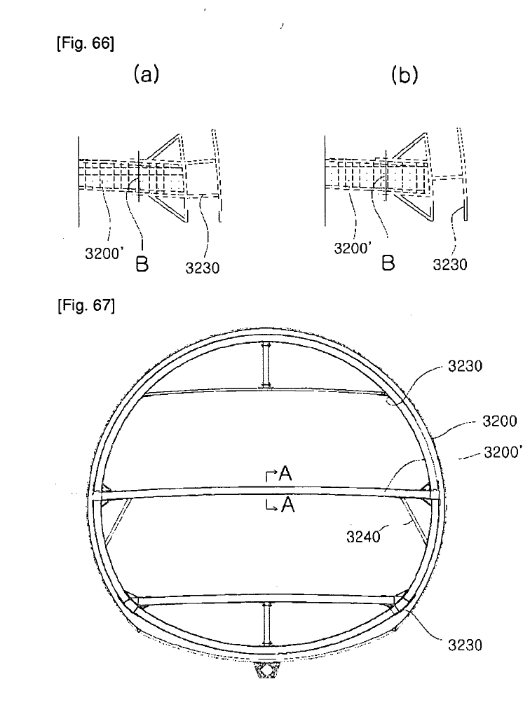

FIGS. 66 through 72 illustrate examples of various structures used when constructing the curved panels 3200.

FIGS. 66 and 67 show a multi-stage tunnel. Referring to FIG. 67, sleeve panels 3200′ are installed in a curved surface shape, thus increasing resistance relative to a relatively large bending stress, which is generated at the central portion thereof. The panels 3200′, which are installed into a multi-stage structure, are coupled to curved panels 3200, which are installed on the inner surface of the tunnel, using connectors 3230.

Furthermore, as shown in FIG. 67, the panels 3200′, which are coupled to the curved panels by the connectors 230, may be additionally reinforced and supported by separate reinforcing members 3240. In addition, as shown in FIG. 66, the reinforcing members 3240 and the connectors 3230 may be coupled to the panels using bolts B, as necessary.

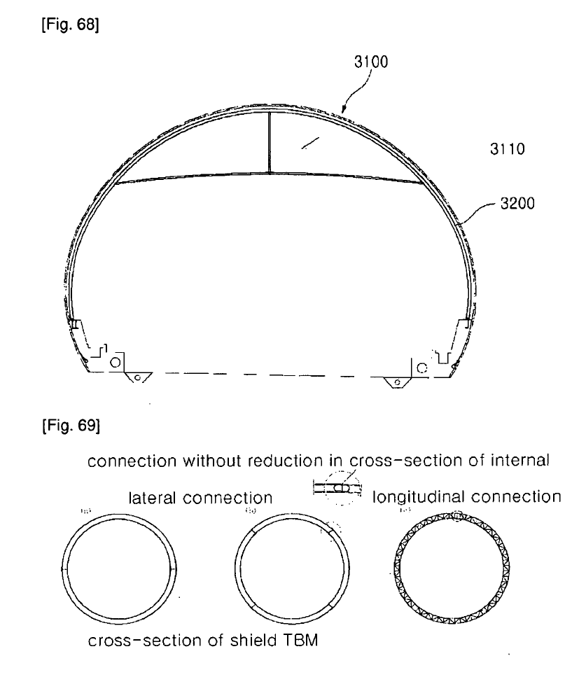

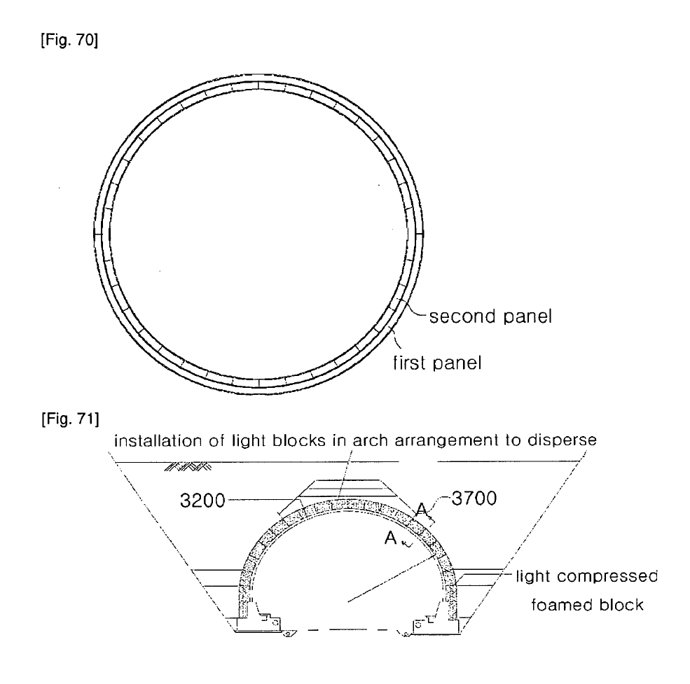

FIG. 68 illustrates the construction of a tunnel, having a ventilation duct therein, using the curved panels. FIGS. 69 and 70 illustrate the construction of curved panels using a shield TBM or an open TBM.

Referring to FIG. 68, the ventilation duct 3110 may be provided in the upper part of the tunnel 3100, and the curved panels 3200 extend to the lower part of the tunnel 3100.

As shown in FIG. 69, when a tunnel is mechanically constructed using the shield TBM or the open TBM or a circular tunnel is bored, in the case of the existing precast lining (not shown), the corners thereof may be easily damaged, and it is relatively heavy, so that the installation thereof is difficult. Furthermore, if hydraulic pressure exists, it is difficult to ensure the waterproofness. However, in the present invention, because the curved panels 3200 are connected to each other in the lateral direction and the longitudinal direction, the coupling force therebetween is increased. Hence, the possibility of damage is markedly reduced. As well, because the curved panels are relatively light, the assembly thereof is facilitated. In addition, reliable waterproofness can be ensured.

As shown in FIG. 70, in the case where the lateral panels and the longitudinal panels are combined with each other, the lateral panels and the longitudinal panels can make up for disadvantages thereof with respect to each other. Furthermore, there is an advantage in that the weight of each panel can be reduced. In this case, the construction of a structure is conducted in the order of boring a tunnel using the shield TBM or the open TBM, first panels are installed, a rear surface gap is filled with filler, adhesive is applied to the first panels, and second panels are installed.

FIG. 71 is a view illustrating a cut-and-cover underground structure. In the construction of the cut-and-cover underground structure, after curved panels are installed, adiabatic substances and lightweight substances for reducing the weight are installed as necessary. To prevent refilling material from falling downwards when refilling, a falling prevention stopper 3700 is installed. Therefore, refilling material can be evenly applied to the side parts and the upper part of the tunnel, thus preventing the panels from being deformed when refilling.

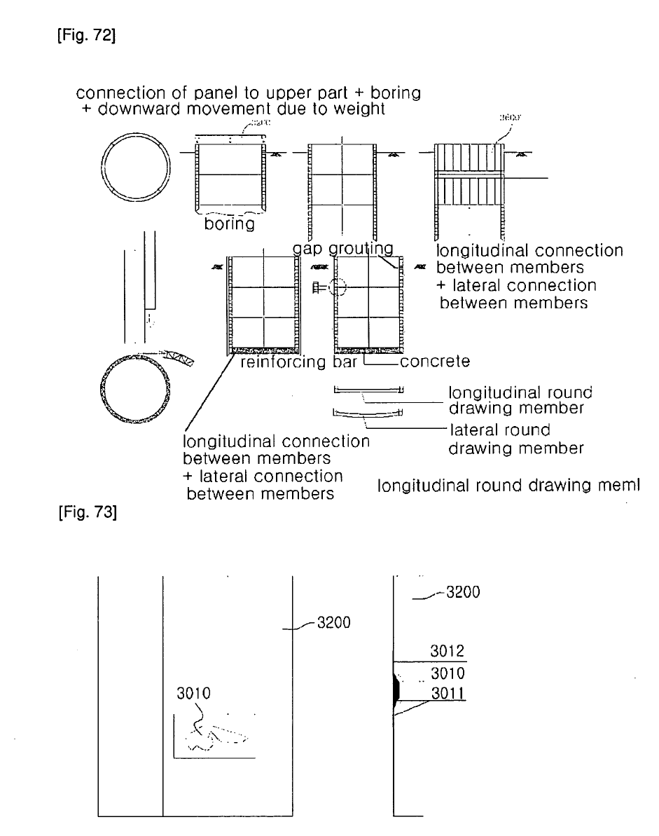

FIG. 72 is a view illustrating a vertical shaft. In the construction of the vertical shaft, it is also preferable that curved panels 3200 and linear panels 3600′ according to the present invention are combined and installed.

FIGS. 73 through 75 are views showing the repair and maintenance of a completed structure.

Referring to FIG. 73, in the case where a damaged portion 3010 occurs on a portion of the outer surfaces of the curved panels 3200, a cold-setting resin adhesive 3011 is applied to the damaged portion 3010, and a high-strength reinforcing fiber sheet 3012 is attached to the portion to which the cold-setting resin adhesive 3011 had been applied.

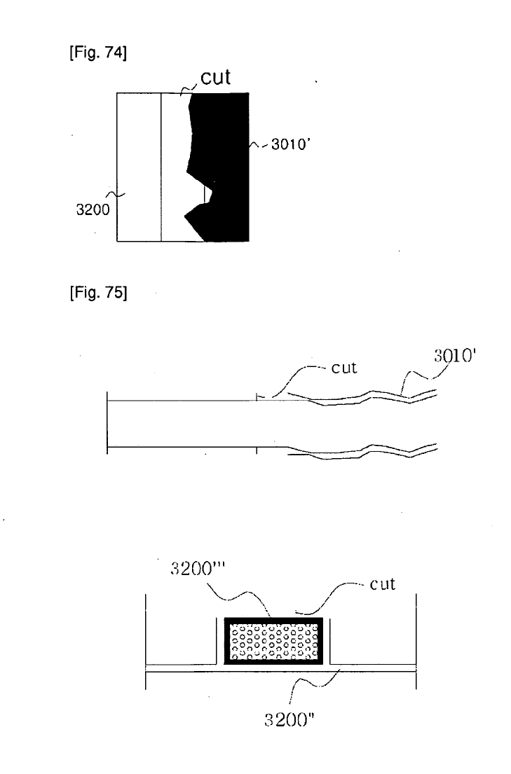

Furthermore, as shown in FIGS. 74 and 75, a damaged part 3010′ may occur in one curved panel 3200. In this case, the damaged part 3010′ is removed from the curved panel 3200.

Thereafter, a connection panel 3220″' is installed in the portion of the curved panel from which the damaged part 3010′ had been removed, and a replacement panel 3200″ is connected to the curved panel 3200 through the connection panel 3200″′.

1. A method of manufacturing a curved panel by bending a fiber reinforcing member, in which fiber is embedded in resin, to form a curved surface in a longitudinal direction thereof, the method comprising:
primarily shaping the fiber reinforcing member into a planar shape; primarily hardening the primarily shaped fiber reinforcing member; secondarily shaping the primarily hardened fiber reinforcing member such that the primarily hardened fiber reinforcing member is bent into a curved shape; secondarily hardening the secondarily shaped fiber reinforcing member by passing the secondarily shaped fiber reinforcing member through a heating room; and continuously drawing the secondarily hardened fiber reinforcing member and cutting the fiber reinforcing member, wherein
the curved surface of the fiber reinforcing member is formed in a direction in which the fiber reinforcing member is drawn.

2. A method of manufacturing a curved panel by bending a fiber reinforcing member, in which a fiber is embedded in resin, to form a curved surface in a longitudinal direction thereof, the method comprising:
primarily shaping the fiber reinforcing member such that the fiber reinforcing member is bent into a curved shape; secondarily shaping the primarily shaped fiber reinforcing member such that the primarily shaped fiber reinforcing member is bent into a curved shape; hardening the secondarily shaped fiber reinforcing member by passing the secondarily shaped fiber reinforcing member through a heating room; and continuously-drawing the secondarily hardened fiber reinforcing member and cutting the fiber reinforcing member, wherein the curved surface of the fiber reinforcing member is formed in a direction in which the fiber reinforcing member is drawn.

3. A method of manufacturing a curved panel by bending a fiber reinforcing member, in which a fiber has been embedded in resin, to form a curved surface in a longitudinal direction thereof, the method comprising:
exposing the fiber reinforcing member to a heating device and primarily shaping the fiber reinforcing member such that the fiber reinforcing member is bent into a curved shape; bending the primarily shaped fiber reinforcing member into a curved shape and hardening the fiber reinforcing member; and drawing the hardened fiber reinforcing member into a curved shape using a drawing roller and cutting the fiber reinforcing member, wherein
the curved surface of the fiber reinforcing member is formed in a direction in which the fiber reinforcing member is drawn.

4. The method of manufacturing the curved panel according to any one of claims 1 through 3, wherein, in the fiber reinforcing member, the fiber is embedded in the resin before the fiber is formed.

5. The method of manufacturing the curved panel according to any one of claims 1 through 3, wherein, in the fiber reinforcing member, the fiber is embedded in the resin after the fiber is formed.

6. The method of manufacturing the curved panel according to claim 5, wherein, in the fiber reinforcing member, after the fiber is formed, the formed fiber is inserted in a mold, and a predetermined amount of resin is injected into the mold using a pump, thus embedding the fiber in the resin.

7. The method of manufacturing the curved panel according to any one of claims 1 through 3, wherein the fiber reinforcing member is continuously drawn by a drawing unit, wherein
the drawing unit comprises a holder to hold the fiber reinforcing member, and guide walls, each of which has a bent shape, the guide walls guiding the holder which guides the fiber reinforcing member in the longitudinal direction.

8. The method of manufacturing the curved panel according to claim 7, wherein the holder comprises a holder body to surround the fiber reinforcing member, a hydraulic jack to fasten the fiber reinforcing member to the holder body, and rollers provided on respective opposite ends of the holder body, wherein the rollers are moved along guide slots, which are formed in the respective guide wall, thus drawing the fiber reinforcing member along the guide walls.

9. The method of manufacturing the curved panel according to any one of claims 1 through 3, wherein the fiber reinforcing member is continuously drawn by a drawing unit, which comprises an endless track device, wherein
the endless track device comprises a pair of gears which rotate using power supplied from an external power source, and an endless track belt having a contact surface of a predetermined width, the endless track belt being wrapped at opposite positions around the gears, so that the endless track belt is moved by the rotation of the gears in an endless track traveling manner, wherein
the endless track belt travels along a curved line, and
the endless track device comprises a pair of endless track devices, which are respectively disposed above and below the fiber reinforcing member to compress the fiber reinforcing member upwards and downwards and move the fiber reinforcing member.

10. The method of manufacturing the curved panel according to any one of claims 1 through 3, wherein the fiber reinforcing member is continuously drawn by a drawing unit, which comprises a roller device, wherein
the roller device comprises one or more rollers to apply force to the fiber reinforcing member upwards or downwards, wherein,
while the fiber reinforcing member is drawn, the curved shape of the fiber reinforcing member is maintained by differences in size and rotating force between the rollers.

11. The method of manufacturing the curved panel according to any one of claims 1 through 3, wherein at least one core is provided in the fiber reinforcing member.

12. The method of manufacturing the curved panel according to claim 11, wherein the core is shaped into a curved shape.

13. The method of manufacturing the curved panel according to claim 11, wherein the core is shaped before the fiber is formed, so that, when the fiber is formed, the core is supplied to the fiber, and the fiber and the core are placed in the mold and a predetermined amount of resin is injected into the mold to embed the fiber and core in the resin, thus forming the fiber reinforcing member, the fiber reinforcing member being shaped by a curved surface forming mold.

14. The method of manufacturing the curved panel according to claim 13, wherein the curved surface forming mold moves in a direction, in which the fiber reinforcing member is moved, and shapes the fiber reinforcing member in a stationary state of the fiber reinforcing member.

15. The method of manufacturing the curved panel according to any one of claims 1 through 3, wherein a composite structure is formed on each of opposite ends of the fiber reinforcing member by a post-process device, wherein
the post-process device comprises an end forming mold coupled to each of the opposite ends of the fiber reinforcing member to form the composite structure, and upper and lower molds are provided on the upper and lower surfaces of the fiber reinforcing member to apply pressure and heat thereto, each of the upper and lower molds having a predetermined curvature.

16. The method of manufacturing the curved panel according to any one of claims 1 through 3, wherein the fiber reinforcing member is provided with a reinforcing sheet for thermal/fire resistance, surface treatment, or reinforcement.

17. An apparatus for manufacturing a curved panel, comprising: a fiber supply unit to supply a fiber, a resin supply unit to supply resin to the fiber to form a fiber reinforcing member; a forming unit to shape the fiber reinforcing member; a drawing unit to continuously draw the shaped fiber reinforcing member; and a cutting unit to cut the drawn fiber reinforcing member, wherein,
to bend the fiber reinforcing member such that the fiber reinforcing member has a curved surface in a longitudinal direction thereof,
the forming unit comprises a first forming part to primarily shape the fiber reinforcing member into a planar shape, a first hardening part to primarily harden the primarily shaped fiber reinforcing member, a second forming part to secondarily shape the primarily hardened fiber reinforcing member by bending the primarily hardened fiber reinforcing member into a curved shape, and a second hardening part to secondarily harden the secondarily shaped fiber reinforcing member, so that
a curved surface is formed in the panel in a direction, in which the panel is drawn.

18. An apparatus for manufacturing a curved panel, comprising: a fiber supply unit to supply a fiber, a resin supply unit to supply resin to the fiber to form a fiber reinforcing member; a forming unit to shape the fiber reinforcing member; a drawing unit to continuously draw the shaped fiber reinforcing member; and a cutting unit to cut the drawn fiber reinforcing member, wherein,
to bend the fiber reinforcing member such that the fiber reinforcing member has a curved surface in a longitudinal direction thereof,
the forming unit comprises a first forming part to primarily shape the fiber reinforcing member into a curved shape, a second forming part to secondarily shape the primarily-formed fiber reinforcing member into a curved shape, and a second hardening part to heat and harden the secondarily shaped fiber reinforcing member, so that
a curved surface is formed in the panel in a direction, in which the panel is drawn.

19. An apparatus for manufacturing a curved panel, comprising: a fiber supply unit to supply a fiber, a resin supply unit to supply resin to the fiber to form a fiber reinforcing member; a forming unit to shape the fiber reinforcing member; a drawing unit to continuously draw the shaped fiber reinforcing member; and a cutting unit to cut the drawn fiber reinforcing member, wherein,
to bend the fiber reinforcing member such that the fiber reinforcing member has a curved surface in a longitudinal direction thereof,
the forming unit comprises a first forming part to primarily shape the fiber reinforcing member into a curved shape, and a second forming part to secondarily shape the primarily formed fiber reinforcing member into a curved shape and harden the fiber reinforcing member, so that
a curved surface is formed in the panel in a direction, in which the panel is drawn.

20. The apparatus for manufacturing the curved panel according to any one of claims 17 through 19, wherein the drawing unit comprises a holder to hold the fiber reinforcing member, and guide walls, each of which has a bent shape, the guide walls guiding the holder which guides the fiber reinforcing member in the longitudinal direction.

21. The apparatus for manufacturing the curved panel according to claim 20, wherein the holder comprises a holder body to surround the fiber reinforcing member, a hydraulic jack to fasten the fiber reinforcing member to the holder body, and rollers provided on respective opposite ends of the holder body, wherein the rollers are moved along guide slots, which are formed in the respective guide wall, thus drawing the fiber reinforcing member along the guide walls.

22. The apparatus for manufacturing the curved panel according to any one of claims 17 through 19, wherein the drawing unit comprises an endless track device, wherein
the endless track device comprises a pair of gears to rotate using power supplied from an external power source, and an endless track belt having a contact surface of a predetermined width, the endless track belt being wrapped at opposite positions thereof around the gears, so that the endless track belt is moved by the rotation of the gears in an endless track traveling manner, wherein
the endless track belt travels along a curved line, and
the endless track device comprises a pair of endless track devices, which are respectively disposed above and below the fiber reinforcing member to compress the fiber reinforcing member upwards and downwards and move the fiber reinforcing member.

23. The apparatus for manufacturing the curved panel according to any one of claims 17 through 19, wherein the drawing unit comprises a roller device, wherein the roller device comprises one or more rollers to apply force to the fiber reinforcing member upwards or downwards, wherein
while the fiber reinforcing member is being drawn, the curved shape of the fiber reinforcing member is maintained by differences in size and rotating force between the rollers.

24. The apparatus for manufacturing the curved panel according to any one of claims 17 through 19, further comprising:
a post-process device comprising an end forming mold coupled to each of opposite ends of the fiber reinforcing member to form a composite structure, and upper and lower molds provided on the upper and lower surfaces of the fiber reinforcing member to apply pressure thereto, each of the upper and lower molds having a predetermined curvature.

25. The apparatus for manufacturing the curved panel according to any one of claims 17 through 19, further comprising:
an angle adjustment unit to adjust a height of the forming unit, such that the direction in which the fiber reinforcing member is discharged from the forming unit, is adjusted, wherein
heights of the guide walls are adjustable along guide wall supports, so that the guide walls are controlled depending on a curved shape of the fiber reinforcing member.

26. A curved panel lining manufactured using panels and provided in an arch structure, the curved panel lining comprising:
a plurality of composite lining members, each of which has a predetermined width and has a predetermined curvature with respect to a longitudinal direction thereof; and
connection means for connecting the adjacent lining members to each other, so that
the lining is disposed in an arch shape in an arch direction of the arch structure, thus ensuring a structural stability, and reducing construction time, wherein each of the composite lining members comprises an upper curved plate having a predetermined curvature in a longitudinal direction thereof, a lower curved plate corresponding to the upper curved plate, and a connection curved member interposed between the upper curved plate and the lower curved plate, the connection curved member has one or more kinds of cross-sectional shape and cross-sectional area determined depending on a shape of a mold used to manufacture the connection curved member, and
the connection curved member has a polygonal cross-section or a circular cross-section in the longitudinal direction, in which the connection curved member is curved.

27. The curved panel lining according to claim 26, wherein a plurality of adhesion protrusions is provided on an outer surface of the lining member.

28. The curved panel lining according to claim 26, wherein the connection means comprises a coupling member interposed between the adjacent lining members, the coupling member covering outer surfaces of facing ends of the adjacent lining members, and a bolt unit for bolting the coupling member to the lining members.

29. The curved panel lining according to claim 26, wherein the connection means comprises a coupling member interposed between the adjacent lining members, the coupling member covering outer surfaces of the facing ends of the adjacent lining members, and an adhesive means applied between the coupling member and the lining members.

30. The curved panel lining according to claim 29, wherein uneven surfaces to be locked to each other are formed in contact surfaces between the coupling member and the lining members.

31. The curved panel lining according to claim 26, wherein the connection means comprises a pair of coupling members interposed between the lining member, the coupling members being coupled to respective facing ends of the adjacent lining members, wherein
the coupling members have respective coupling protrusions, so that the coupling members are coupled to each other by connection between the coupling protrusions.

32. The curved panel lining according to claim 26, wherein the connection means comprises a pair of coupling members interposed between the lining member, the coupling members being coupled to respective facing ends of the adjacent lining members, wherein
the coupling members are coupled to each other using a coupling insertion locked to both the coupling members.

33. The curved panel lining according to claim 26, wherein the connection means comprises coupling parts formed in respective facing ends of the adjacent lining members, and a connection member interposed between the lining members, the connection member being coupled at opposite ends thereof to the respective coupling parts, wherein
each of the coupling parts is a depression formed in the corresponding end of each of the lining members, and
the connection member comprises a protrusion body inserted at opposite ends thereof into the respective depressions, and a center body provided in a central portion of the protrusion body, the center body being disposed between the lining members such that the center body is brought into close contact with the lining members.

34. The curved panel lining according to claim 33, wherein the depression has a round inner surface, and
the protrusion body has a round outer surface such that the protrusion body comes into close contact with the depression.

35. The curved panel lining according to any one of claims 28 through 33, wherein upper and lower surfaces of the coupling member protrude outwards from the outer surfaces of the lining members, wherein
the upper and lower surface of the coupling member are rounded.

36. The curved panel lining according to claim 26, wherein the connection means comprises a connector having a predetermined length, the connector being interposed between the adjacent lining members and coupled to facing ends of the adjacent lining members, the connector having upper and lower surfaces of different lengths.

37. The curved panel lining according to claim 36, wherein the connector has a first space, into which insert material is inserted, and a second space connected to the first space, the second space being filled with reinforcing material, so that the length of the connector is changed by insertion of the insert material in a state wherein the reinforcing material is charged into the second space.

38. The curved panel lining according to claim 26, wherein a reinforcing panel is attached to outer surfaces of the lining members.

39. The curved panel lining according to claim 26, wherein concrete is applied to outer surfaces of the lining members.

40. A curved panel construction method for constructing a lining, the lining being manufactured using panels and constructed in an arch structure, the construction method comprising:
preparing a plurality of composite curved panels, each of which has a predetermined width and has a predetermined curvature with respect to a longitudinal direction thereof, the composite curved panels having one or more kinds of cross-sectional shapes and cross-sectional areas,
boring the arch structure or leveling a ground, and
installing the prepared curved panels in the arch structure in an arch direction of the arch structure to form a curved shape, thus reducing a construction time, and increasing a supporting force, wherein
the installation of the curved panels comprises
installing precast panel supports in the arch structure, and
supporting the curved panel on the installed precast panel supports, wherein,
while the arch structure is bored, the curved panels are consecutively installed, and, thereafter, the precast panel supports, on which the curved panels are supported, are covered with finishing material in one operation.

41. The curved panel construction method according to claim 1, wherein a height adjustment device is provided on the precast panel supports, so that heights of the curved panels are adjusted using the height adjustment device.

42. A curved panel construction method for constructing a lining, the lining being manufactured using panels and constructed in an arch structure, the construction method comprising:
preparing a plurality of composite curved panels, each of which has a predetermined width and has a predetermined curvature with respect to a longitudinal direction thereof, the composite curved panels having one or more kinds of cross-sectional shapes and cross-sectional areas,
boring the arch structure or leveling a ground, and
installing the prepared curved panels in the arch structure in an arch direction of the arch structure to form a curved shape, thus reducing a construction time, and increasing a supporting force, wherein,
in the installation of the curved panels, after the arch structure is bored to a predetermined distance, concrete structures for supporting the curved panels are installed, and the curved panels are installed in one operation such that the curved panels are supported by the concrete structures.

43. The curved panel construction method according to claim 42, wherein guides are provided on upper ends of the concrete structures, and lower ends of the curved panels are inserted into the corresponding guides, so that
the curved panels are installed in the arch structure by pushing the curved panels from one end of the arch structure into the arch structure under guidance of the guides.

44. The curved panel construction method according to claim 42, wherein the curved panels are installed in the arch structure by disposing the curved panels at different positions in the arch structure and pushing the curved panels to an inner surface of the arch structure.

45. The curved panel construction method according to claim 40 or 42, wherein a filler is charged between the curved panels and an inner surface of the arch structure.

46. The curved panel construction method according to claim 45, wherein an injection hole is formed in the curved panel, so that the filler is injected through the injection hole.

47. The curved panel construction method according to claim 46, wherein the injection hole is a threaded hole, through which the filler passes, and a stop bolt is inserted into the threaded hole to openably close the threaded hole.

48. The curved panel construction method according to claim 40 or 42, wherein a gap is defined between the curved panels and an inner surface of the arch structure.

49. The curved panel construction method according to claim 40 or 42, wherein each of the curved panels is fastened to a base rock, in which the arch structure is placed, using a locking bolt.

50. The curved panel construction method according to claim 49, wherein the locking bolt is brought into close contact with the curved panel.

51. The curved panel construction method according to claim 49, wherein the locking bolt is spaced apart from the curved panel by a predetermined distance.

52. The curved panel construction method according to claim 49, wherein a cap nut is provided on a rear surface of the curved panel so that an end of the locking bolt is fitted into the cap nut.

53. The curved panel construction method according to claim 40 or 42, wherein, after the arch structure is bored,
a first lining is formed by arranging linear panels, each of which has a round cross-section and has a predetermined length, around an inner surface of the arch structure, and
a second lining is formed by covering the first lining with the curved panels.

54. The curved panel construction method according to claim 53, wherein
the first lining is formed by supplying to and installing the linear panels in the arch structure after the linear panels are assembled with each other,
the second lining is formed by supplying to and installing the curved panels in the arch structure after the curved panels are assembled with each other, or by directly installing the curved panels at installation positions in the arch structure, the arch structure is further bored and additional linear panels are supplied into and installed in the arch structure, and
additional curved panels are installed in the arch structure.

55. The curved panel construction method according to claim 40 or 42, wherein, when a damaged portion occurs on portion of outer surfaces of the curved panels, an adhesive is applied to the damaged portion, and
a high-strength reinforcing fiber sheet is attached to the portion to which the adhesive is applied.

56. The curved panel construction method according to claim 40 or 42, wherein, when a damaged part occurs in one curved panel,
the damaged part is removed from the curved panel,
a connection panel is installed in a portion of the curved panel from which the damaged part has been removed, and
a replacement panel is connected to the curved panel through the connection panel.
